(19) United States
(12) Patent Application Publication
(10) Pub. No.: US 2017/0285765 A1
(43) Pub. Date: Oct. 5, 2017

(54) INPUT APPARATUS, INPUT METHOD, AND COMPUTER PROGRAM

(71) Applicant: SEIKO EPSON CORPORATION, Tokyo (JP)

(72) Inventor: Fusashi KIMURA, Matsumoto-shi (JP)

(73) Assignee: SEIKO EPSON CORPORATION, Tokyo (JP)

(21) Appl. No.: 15/466,250

(22) Filed: Mar. 22, 2017

(30) Foreign Application Priority Data
Mar. 29, 2016 (JP) 2016-064894
Nov. 15, 2016 (JP) 2016-222259

(51) Int. Cl. G06F 3/023; G06F 3/02

(52) U.S. Cl. CPC G06F 3/0238; G06F 3/0219

(57) ABSTRACT

An input apparatus includes at least two buttons each of which is allowed to have an input-on state and an input-off state and a control section, and the control section performs output corresponding to flick input in a case where a result of detection of the states of the buttons includes a pre-specified pattern.

### BACKGROUND

### 1. Technical Field

The present invention relates to an input apparatus.

### 2. Related Art

As an input method used with a smartphone and other apparatus, flick input is known (see JP-A-2013-33395, for example). The flick input means operation in general of quickly moving a finger or tapping a finger on a touchpad. The flick input is known, for example, as an approach for quickly allowing letter input using a software keyboard.

To perform the flick input, an input apparatus needs to be provided with a sensor device that can acquire the trajectory of a finger or any other object, for example, a touchpad or a touch panel. On the other hand, there are a large number of input apparatus that include no sensor device that can acquire the trajectory of a finger or any other object, for example, a remote control or a controller having a cross key and several buttons. Such an input apparatus of related art undesirably allows the flick input.

An input apparatus that allows flick input without use of a sensor device that can acquire the trajectory of a finger or any other object has therefore been desired.

### SUMMARY

An advantage of some aspects of the invention is to solve at least a part of the problems described above, and the invention can be implemented as the following forms.

(1) According to an aspect of the invention, an input apparatus is provided. The input apparatus includes at least two buttons each of which is allowed to have an input-on state and an input-off state and a control section, and the control section performs output corresponding to flick input in a case where a result of detection of the states of the buttons includes a pre-specified pattern.

According to the input apparatus of this aspect, in the case where at least two buttons each of which is allowed to have an input-on state and an input-off state are used and a result of the detection of the states of the buttons contains a pre-specified pattern, the output corresponding to the flick input is performed. As a result, a user can perform flick input without using any sensor device that can acquire the trajectory of a finger or any other object.

(2) In the input apparatus according to the aspect described above, the at least two buttons may include a finalizing button and direction buttons corresponding to upward, downward, rightward, and leftward directions, and the pre-specified pattern may correspond to detection of the on/off state of the finalizing button, followed by detection of the on state of any one of the direction buttons.

According to the input apparatus with the configuration described above, when the finalizing button is pressed (or touched) and any one of the direction buttons is then pressed (or touched), in other words, in response to movement of a finger before and after pressing/touching actions, output corresponding to the flick input is performed. As a result, the user can perform flick input through a finger movement action that mimics an actual flick action.

(3) In the input apparatus according to the aspect described above, the pre-specified pattern may correspond to detection of the on/off state of the finalizing button, followed by detection of the on state of any one of the direction buttons before a pre-specified first period elapses.

According to the input apparatus with the configuration described above, output corresponding to the flick input is performed only in the case where the period between the timing of the pressing (or touching) operation of the finalizing button and the timing of pressing (or touching) operation of a direction button is shorter than or equal to the first period. Appropriately setting the first period allows the user to properly use the following two types of operation: typical finalization-direction input; and flick input.

(4) In the input apparatus according to the aspect described above, the pre-specified pattern may correspond to detection of the on state of the finalizing button, followed by detection of the off state of the finalizing button after a pre-specified second period elapses, further followed by detection of the on state of any one of the direction buttons.

According to the input apparatus with the configuration described above, output corresponding to the flick input is performed only in the case where the period from the start of pressing (or touching) operation of the finalizing button to the end of the pressing (or touching) operation of the finalizing button is longer than the second period. Appropriately setting the second period allows the user to intentionally use the following two types of operation properly in response to the long pressing operation of the finalizing button: typical finalization-direction input; and flick input.

(5) In the input apparatus according to the aspect described above, the at least two buttons may include a finalizing button and direction buttons corresponding to upward, downward, rightward, and leftward directions, and the pre-specified pattern may correspond to detection of the on/off state of the finalizing button twice, followed by detection of the on state of any one of the direction buttons.

According to the input apparatus with the configuration described above, output corresponding to the flick input is performed only in the case where the finalizing button is pressed (or touched) twice and then a direction button is pressed (or touched). The user can therefore properly use the following two types of operation: typical finalization-direction input; and flick input.

(6) In the input apparatus according to the aspect described above, the at least two buttons may be formed of a cross key having the finalizing button located at a center and the direction buttons arranged in upward, downward, rightward, and leftward directions with respect to the finalizing button.

According to the input apparatus with the configuration described above, the finalizing button and the direction buttons can be configured as the cross key that is readily understood and operated by the user in an intuitive manner.

(7) In the input apparatus according to the aspect described above, the at least two buttons may be each formed of a mechanical-contact button.

According to the input apparatus with the configuration described above, mechanical-contact buttons can be used to form the input apparatus.

(8) In the input apparatus according to the aspect described above, the at least two buttons may be each formed of a capacitance button.

According to the input apparatus with the configuration described above, capacitance buttons can be used to form the input apparatus.

(9) In the input apparatus according to the aspect described above, as the output corresponding to the flick input, a letter selected by the flick input may be outputted.

According to the input apparatus with the configuration described above, the flick input can be used as letter input.

(10) The input apparatus according to the aspect described above may further include an interface for connection to an image display section that allows, when the input apparatus is mounted on a user's head, the user to visually recognize a virtual image. The control section may further have a function of producing image data and outputting the produced image data to the image display section and an operating system that allows execution of a variety of application programs, and the control section may produce a flick event according to each operation that forms the flick input and coordinate with the operation system to perform the output corresponding to the flick input.

The input apparatus according to the aspect described above can be configured as a controller that operates and controls the image display section.

(11) In the input apparatus according to the aspect described above, the control section may further have an operating system that allows execution of a variety of application programs, and the control section may produce a flick event according to each operation that forms the flick input and coordinate with the operation system to perform the output corresponding to the flick input.

The input apparatus according to the aspect described above can be configured as a computer that can execute a variety of application programs.

(12) The input apparatus according to the aspect described above may further include an interface for connection to an external apparatus, and the control section may output the output corresponding to the flick input to the external apparatus via the interface.

The input apparatus with the configuration described above can be configured as a device that performs input to an external apparatus.

All the components provided in the aspect of the invention described above are not essential, and to solve part or entirety of the problems described above, or to achieve part or entirety of the advantageous effects described in the present specification, part of the components can be changed, omitted, and replaced with new components, and limiting factors of the components are partially omitted as appropriate. Further, to solve part or entirety of the problems described above or to achieve part or entirety of the advantageous effects described in the present specification, part or entirety of the technical features contained in any one of the aspects of the invention described above can be combined with part or entirety of the technical features contained in another one of the aspects of the invention described above into an independent form of the invention.

The invention can be implemented in a variety of aspects, for example, as follows: an input apparatus; a head mounted display that is a combination of an input apparatus and an image display section; a system that is a combination of an input apparatus and a head mounted display; a system that is a combination of an input apparatus and an information processing apparatus; an input method; a computer program for achieving the functions of the apparatus, the system, and the method described above; a server apparatus for distributing the computer program; and a storage medium that stores the computer program.

### BRIEF DESCRIPTION OF THE DRAWINGS

The invention will be described with reference to the accompanying drawings, wherein like numbers reference like elements.

FIG. 1 shows the exterior configuration of an HMD in an embodiment of the invention.

FIG. 2 is a key part plan view showing the configuration of an optical system provided in an image display section.

FIG. 3 shows the configuration of key parts of the image display section viewed from a user.

FIG. 4 describes the angle of view of a camera.

FIG. 5 is a functional block diagram showing the configuration of the HMD.

FIG. 6 is a functional block diagram showing the configuration of a control function section of the HMD.

FIG. 7 describes a cross key.

FIG. 8 describes a flick input method using the cross key.

FIG. 9 shows examples of an operation pattern that causes a control apparatus to perform output corresponding to flick input.

FIG. 10 describes patterned operation.

FIG. 11 describes the patterned operation.

FIG. 12 describes the patterned operation.

FIG. 13 describes patterned operation.

FIG. 14 describes another configuration of the cross key.

FIG. 15 describes another configuration of the cross key.

FIG. 16 describes another configuration of the cross key.

FIG. 17 describes patterned operation.

FIG. 18 describes the patterned operation.

FIG. 19 describes the patterned operation.

FIG. 20 describes the patterned operation.

FIG. 21 is a descriptive diagram showing a first use state in which a control apparatus is used in a third embodiment.

FIG. 22 is a descriptive diagram showing a second use state in which the control apparatus is used.

FIG. 23 describes another configuration of operation of switching Japanese input to alphabetical letter input and vice versa.

FIG. 24 is a key part plan view showing the configuration of an optical system provided in an image display section according to a variation.

### DESCRIPTION OF EXEMPLARY EMBODIMENTS

### A. First Embodiment

### A-1. Configuration of HMD:

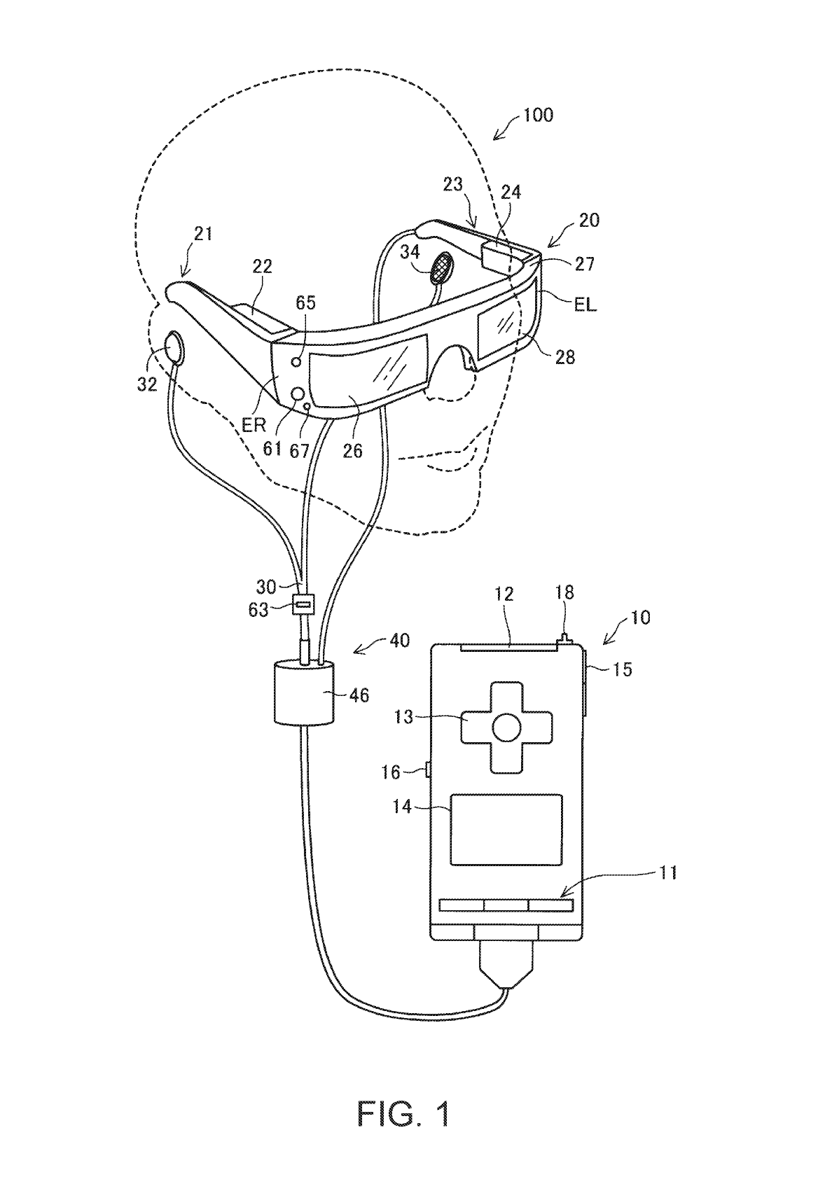

FIG. 1 shows the exterior configuration of an HMD (head mounted display) 100 in a first embodiment of the invention. The HMD 100 is a display apparatus including an image display section 20 (display section), which is mounted on a user's head and allows the user to visually recognize a virtual image, and a control apparatus 10 (control section), which controls the image display section 20. The control apparatus 10 includes a variety of input devices for acquiring the user's operation and functions as a controller that allows the user to operate the HMD 100. The control apparatus 10 in the present embodiment also functions as an “input apparatus” that allows flick input without use of a sensor device that can acquire the trajectory of a finger or any other object.

The image display section 20 is a mountable part mounted on the user's head and has a spectacle-like shape in the present embodiment. The image display section 20 includes a main body including a right holder 21, a left holder 23, and a front frame 27, and the main body is provided with a right display unit 22, a left display unit 24, a right light guide plate 26, and a left light guide plate 28.

The right holder 21 and the left holder 23, which extend rearward from opposite ends of the front frame 27, hold the image display section 20 on the user's head as temples (bows) of spectacles do. One of the opposite ends of the front frame 27 or the end located on the right of the user on whom the image display apparatus 20 is mounted is called an end ER, and the other end or the end located on the left of the user is called an end EL. The right holder 21 is so provided as to extend from the end ER of the front frame 27 to a position corresponding to a right temporal region of the user on whom the image display section 20 is mounted. The left holder 23 is so provided as to extend from the end EL of the front frame 27 to a position corresponding to a left temporal region of the user on whom the image display section 20 is mounted.

The right light guide plate 26 and the left light guide plate 28 are provided as part of the front frame 27. The right light guide plate 26 is located in front of the right eye of the user on whom the image display section 20 is mounted and allows the right eye to visually recognize an image. The left light guide plate 28 is located in front of the left eye of the user on whom the image display section 20 is mounted and allows the left eye to visually recognize an image.

The front frame 27 has a shape that links one end of the right light guide plate 26 and one end of the left light guide plate 28 to each other. The linkage position corresponds to a position between the eyes of the user on whom the image display section 20 is mounted. A nose pad that comes into contact with the nose of the user on whom the image display section 20 is mounted may be provided as part of the front frame 27 and in the position where the right light guide plate 26 and the left light guide plate 28 are linked to each other. In this case, the nose pad, the right holder 21, and the left holder 23 can hold the image display section 20 on the user's head. Further a belt that comes into contact with the back of the head of the user on whom the image display section 20 is mounted may be linked to the right holder 21 and the left holder 23. In this case, the belt can securely hold the image display section 20 on the user's head.

The right display unit 22 displays an image via the right light guide plate 26. The right display unit 22 is provided on the right holder 21 and located in the vicinity of the right temporal region of the user on whom the image display section 20 is mounted. The left display unit 24 displays an image via the left light guide plate 28. The left display unit 24 is provided on the left holder 23 and located in the vicinity of the left temporal region of the user on whom the image display section 20 is mounted. The right display unit 22 and the left display unit 24 are also collectively called “display drivers.”

The right light guide plate 26 and the left light guide plate 28 in the present embodiment are each an optical section (prism, for example) made, for example, of a light transmissive resin and guide image light outputted from the right display unit 22 and the left display unit 24 to the user's eyes. A light control plate may be provided on the surface of each of the right light guide plate 26 and the left light guide plate 28. The light control plate is a thin-plate-shaped optical element having transmittance that varies in accordance with the range of the wavelength of light passing therethrough and functions as what is called a wavelength filter. The light control plates are so disposed as to cover, for example, part of the front surface of the front frame 27 (surface opposite the surface facing the user's eyes). Appropriate selection of optical characteristics of the light control plates allows adjustment of light transmittance in an arbitrary wavelength range, such as visible light, infrared light, and ultraviolet light and therefore allows adjustment of the amount of outside light externally incident on the right light guide plate 26 and the left light guide plate 28 and passing through the right light guide plate 26 and the left light guide plate 28.

The image display section 20 guides the image light produced by the right display unit 22 and the left display unit 24 to the right light guide plate 26 and the left light guide plate 28 and allows the user to visually recognize virtual images produced by the image light (this action is also called “displaying images”). In a case where outside light passes through the right light guide plate 26 and the left light guide plate 28 from the side in front of the user and impinges on the user's eyes, the image light that forms virtual images and the outside light are incident on the user's eyes. The visibility of the virtual images viewed by the user is therefore affected by the intensity of the outside light.

Therefore, for example, attaching the light control plates to the front frame 27 and selecting or adjusting the optical characteristics of the light control plates as appropriate allow adjustment of the visibility of the virtual images. In a typical example, light control plates having light transmittance high enough to at least allow the user on whom the HMD 100 is mounted to visually recognize an outside scene can be selected. When the light control plates are used, it can be expected to achieve an effect of protecting the right light guide plate 26 and the left light guide plate 28 and suppressing damage of the right light guide plate 26 and the left light guide plate 28, adhesion of dirt thereto, and other undesirable effects thereon. The light control plates may be attachable to and detachable from the front frame 27 or the right light guide plate 26 and the left light guide plate 28. A plurality of types of light control plates may be changed from one to another in an attachable/detachable manner, or the light control plates may be omitted.

A camera 61 is disposed in the front frame 27 of the image display section 20. The camera 61 is provided in the front surface of the front frame 27 and in a position where the camera 61 does not block the outside light passing through the right light guide plate 26 and the left light guide plate 28. In the example shown in FIG. 1, the camera 61 is disposed on the side facing the end ER of the front frame 27. The camera 61 may instead be disposed on the side facing the end EL of the front frame 27 or in the portion where the right light guide plate 26 and the left light guide plate 28 are linked to each other.

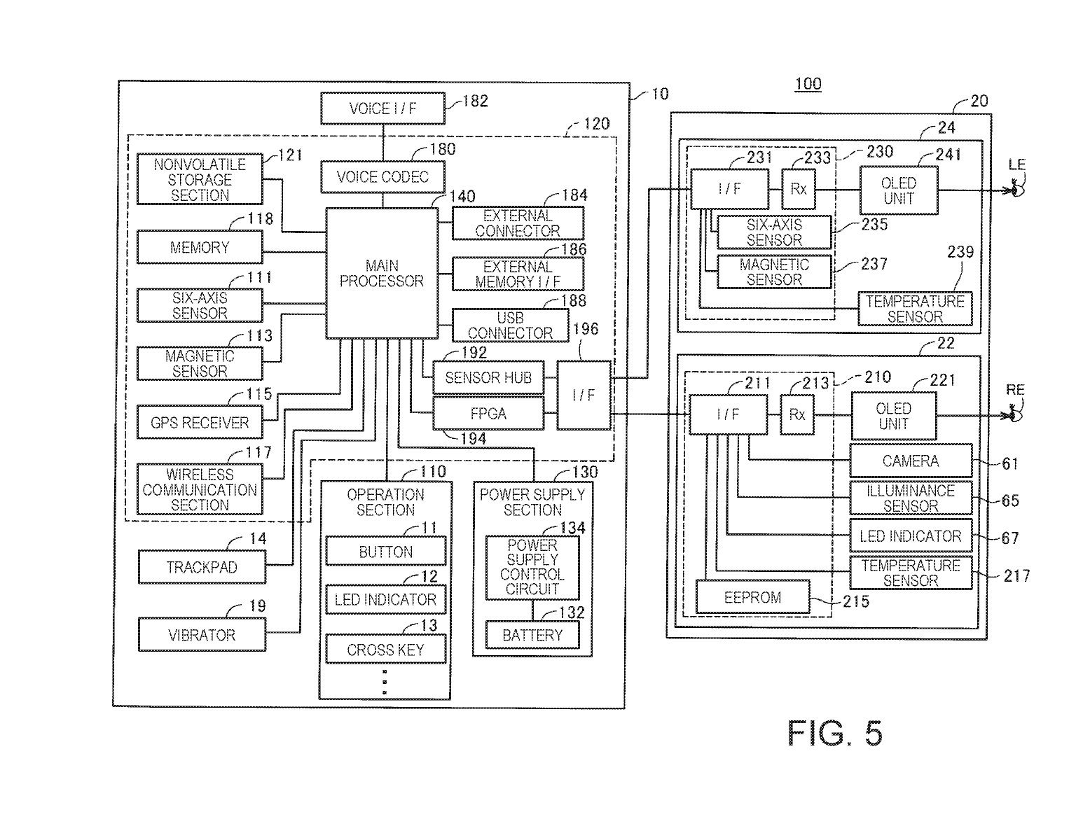

The camera 61 is a digital camera including an imaging element, such as a CCD or a CMOS element, an imaging lens, and other components. The camera 61 in the present embodiment is a monocular camera but may instead be a stereocamera. The camera 61 captures an image of at least part of an outside scene (real space) in the direction extending from the front side of the HMD 100, in other words, in the direction toward the visual field of the user on whom the image display section 20 is mounted. In other words, the camera 61 performs imaging over the range or in the direction that overlaps with the user's visual field and performs imaging in the direction in which the user gazes. The angle of view of the camera 61 can be set as appropriate. In the present embodiment, the angle of view of the camera 61 is so set that the camera 61 captures an image of the user's entire visual field over which the user can gaze through the right light guide plate 26 and the left light guide plate 28. The camera 61 performs imaging under the control of a control section 150 (FIG. 5) and outputs captured image data to the control section 150.

The HMD 100 may include a distance measuring sensor that detects the distance to a measurement target object positioned in a measurement direction set in advance. The distance measuring sensor can, for example, be disposed in a portion of the front frame 27 or the portion where the right light guide plate 26 and the left light guide plate 28 are linked to each other. The measurement direction of the distance measuring sensor can be a direction extending from the front side of the HMD 100 (direction that overlaps with the imaging direction of the camera 61). The distance measuring sensor can be formed, for example, of a light emitter, such as an LED and a laser diode, and a light receiver that receives light emitted from the light source and reflected off the measurement target object. In this case, the distance is determined by triangulation or a distance measurement process based on time difference. The distance measuring sensor may instead be formed, for example, of a transmitter that emits an ultrasonic wave and a receiver that receives the ultrasonic wave reflected off the measurement target object. In this case, the distance is determined by a distance measurement process based on time difference. The distance measuring sensor is controlled by the control section 150 and outputs a result of the detection to the control section 150, as in the case of the camera 61.

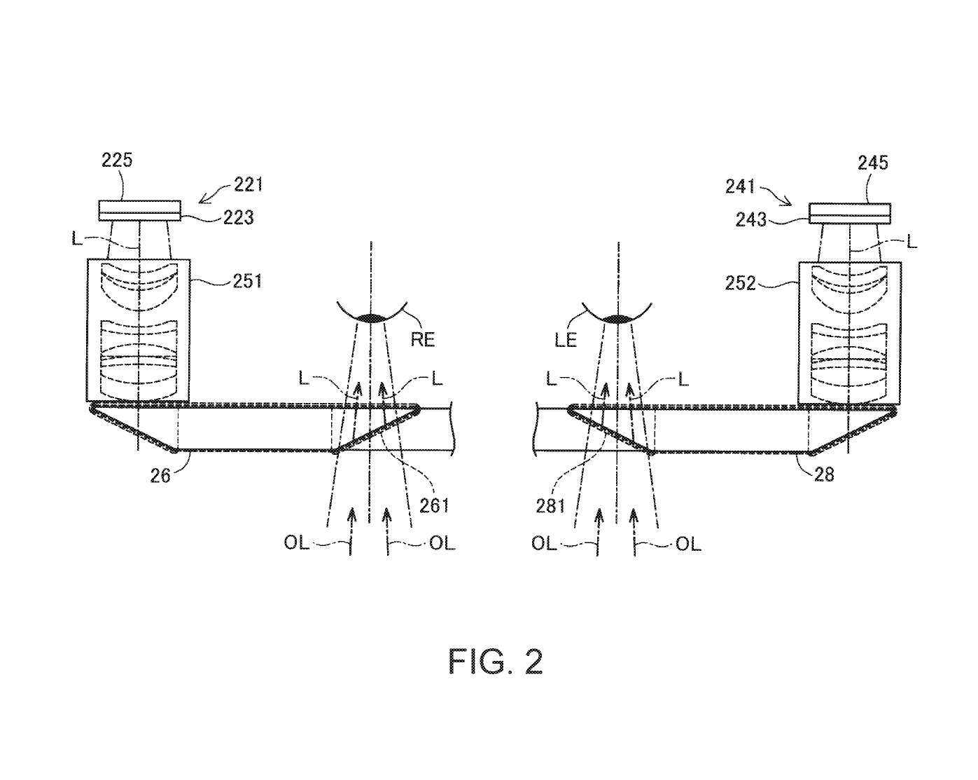

FIG. 2 is a key part plan view showing the configuration of an optical system provided in the image display section 20. FIG. 2 shows the user's right eye RE and left eye LE for ease of description. The right display unit 22 and the left display unit 24 are configured to have a bilaterally symmetric structure, as shown in FIG. 2.

As the configuration that allows the right eye RE to visually recognize a virtual image, the right display unit 22 includes an OLED (organic light emitting diode) unit 221 and a right optical system 251. The OLED unit 221 emits image light. The right optical system 251 includes lens groups and other components and guides the image light L emitted from the OLED unit 221 to the right light guide plate 26.

The OLED unit 221 includes an OLED panel 223 and an OLED drive circuit 225, which drives the OLED panel 223. The OLED panel 223 is a self-luminous display panel formed of light emitting elements that emit R (red), G (green), and B (blue) color light fluxes on the basis of organic electroluminescence. The OLED panel 223 has a plurality of pixels arranged in a matrix, and each of the pixels is a light emitting unit formed of one R element, one G element, and one B element.

The OLED drive circuit 225 selects a light emitting element provided in the OLED panel 223 and supplies the light emitting element with electric power to cause the light emitting element to emit light under the control of the control section 150 (FIG. 5). The OLED drive circuit 225 is fixed to the rear surface of the OLED panel 223, that is, the rear side of the light emitting surface, for example, in a bonding process. The OLED drive circuit 225 may be formed, for example, of a semiconductor device that drives the OLED panel 223 and mounted on a substrate fixed to the rear surface of the OLED panel 223. A temperature sensor 217, which will be described later, is mounted on the substrate. The OLED panel 223 may instead have a configuration in which light emitting elements that emit white light are arranged in a matrix and color filters corresponding to the R, G, and B three colors are so disposed as to be superimposed on the light emitting elements. Still instead, an OLED panel 223 having a WRGB configuration including light emitting elements that radiate W (white) light in addition to the light emitting elements that radiate the R, G, and B color light fluxes may be employed.

The right optical system 251 includes a collimator lens that converts the image light L outputted from the OLED panel 223 into a parallelized light flux. The image light L having been converted by the collimator lens into a parallelized light flux is incident on the right light guide plate 26. A plurality of reflection surfaces that reflect the image light L are formed along the optical path that guides the light in the right light guide plate 26. The image light L undergoes reflection multiple times in the right light guide plate 26 and is guided toward the right eye RE. A half-silvered mirror 261 (reflection surface) located in front of the right eye RE is formed on the right light guide plate 26. The image light L is reflected off the half-silvered mirror 261, then exits out of the right light guide plate 26 toward the right eye RE, and forms an image on the retina of the right eye RE, whereby a virtual image is visually recognized by the user.

As the configuration that allows the left eye LE to visually recognize a virtual image, the left display unit 24 includes an OLED unit 241 and a left optical system 252. The OLED unit 241 emits image light. The left optical system 252 includes lens groups and other components and guides the image light L emitted from the OLED unit 241 to the left light guide plate 28. The OLED unit 241 includes an OLED panel 243 and an OLED drive circuit 245, which drives the OLED panel 243. Details of the portions described above are the same as those of the OLED unit 221, the OLED panel 223, and the OLED drive circuit 225. A temperature sensor 239 is mounted on a substrate fixed to the rear surface of the OLED panel 243. Details of the left optical system 252 are the same as those of the right optical system 251.

The HMD 100 having the configuration described above can function as a see-through-type display apparatus. That is, on the user's right eye RE are incident the image light L reflected off the half-silvered mirror 261 and outside light OL having passed through the right light guide plate 26. On the user's left eye LE are incident the image light L reflected off the half-silvered mirror 281 and outside light OL having passed through the left light guide plate 28. The HMD 100 thus causes the image light L carrying internally processed images and the outside light OL to be superimposed on each other and causes the superimposed light to be incident on the user's eyes. As a result, the user views an outside scene (real world) through the right light guide plate 26 and the left light guide plate 28 and visually recognizes virtual images formed by the image light L and superimposed on the outside scene.

The half-silvered mirror 261 and the half-silvered mirror 281 function as “image extracting sections” that reflect the image light outputted from the right display unit 22 and the left display unit 24 and extract images from the image light. The right optical system 251 and the right light guide plate 26 are also collectively called a “right light guide unit,” and the left optical system 252 and the left light guide plate 28 are also collectively called a “left light guide unit.” The configuration of the right and left light guide units is not limited to the example described above and can be arbitrarily configured as long as the image light is used to form virtual images in positions in front of the user's eyes. A diffraction grating or a half-transmissive/reflective film may, for example, be used as each of the right and left light guide units.

In FIG. 1, the control apparatus 10 and the image display section 20 are connected to each other via a connection cable 40. The connection cable 40, which is detachably connected to a connector provided on the lower side of the control apparatus 10, is inserted through the end of the left holder 23 and connected to a variety of circuits in the image display section 20. The connection cable 40 includes a metal cable or an optical fiber cable through which digital data is transmitted. The connection cable 40 may further include a metal cable through which analog data is transmitted. A connector 46 is provided in a halfway position along the connection cable 40.

The connector 46 is a jack to which a stereo mini plug is connected, and the connector 46 is connected to the control apparatus 10, for example, via a line through which an analog voice signal is transmitted. In the example of the present embodiment shown in FIG. 1, a headset 30 including a right earphone 32 and a left earphone 34, which form a stereo headphone, and a microphone 63 is connected to the connector 46.

The microphone 63 is so disposed that a sound collector of the microphone 63 faces in the direction of the user's line of sight as shown, for example, in FIG. 1. The microphone 63 collects voice and outputs a voice signal to a voice interface 182 (FIG. 5). The microphone 63 may be a monaural microphone, a stereo microphone, a directional microphone, or an omni-directional microphone.

The control apparatus 10 includes, as an input/output user interface, buttons 11, an LED indicator 12, a cross key 13, a trackpad 14, up/down keys 15, a changeover switch 16, and a power switch 18.

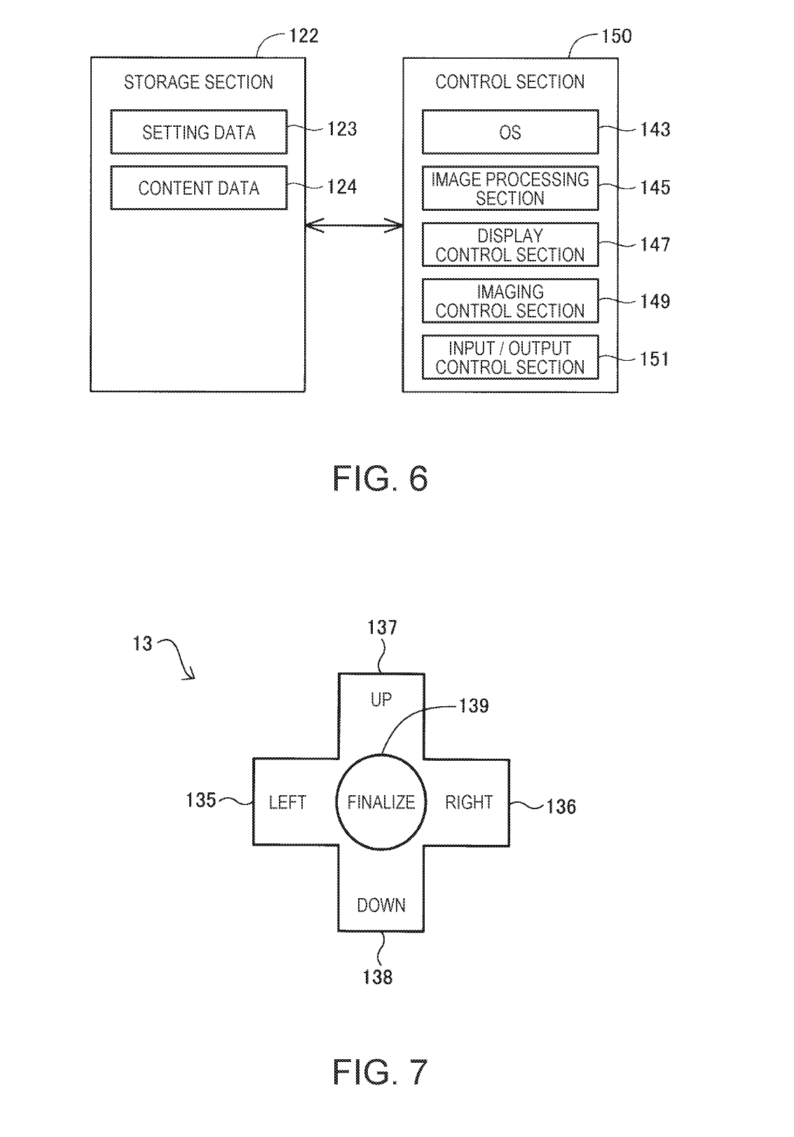

The buttons 11 are formed of a menu key, a home key, a return key, and other switches for operating or otherwise manipulating an OS (operation system) 143 (FIG. 6) executed by the control apparatus 10. The buttons 11 in the present embodiment are buttons that are displaced in response to operation of pressing the keys and switches. The LED indicator 12 goes on and off in correspondence with the action state of the HMD 100. The cross key 13 detects operation of touching or pressing a key corresponding to any of the upward, downward, rightward, leftward, and central portions of the cross key 13 and outputs a signal according to the content of the detection. The trackpad 14 has an operation surface that detects contact operation, detects contact operation performed on the operation surface, and outputs a signal according to the content of the detection. A method for detecting contact operation can be an electrostatic method, a pressure detection method, an optical method, or any of a variety of other methods.

The up/down keys 15 detect instruction operation for increasing and decreasing the magnitude of sound outputted from the right earphone 32 and the left earphone 34 and instruction operation for increasing and decreasing the brightness of an image displayed by the image display section 20. The changeover switch 16 detects operation of switching the target of the instruction issued by the up/down keys 15 from one to the other (magnitude of sound, brightness of image). The power switch 18 detects operation of powering on and off the HMD 100 (ON, OFF). The power switch 18 can be formed, for example, of a slide switch.

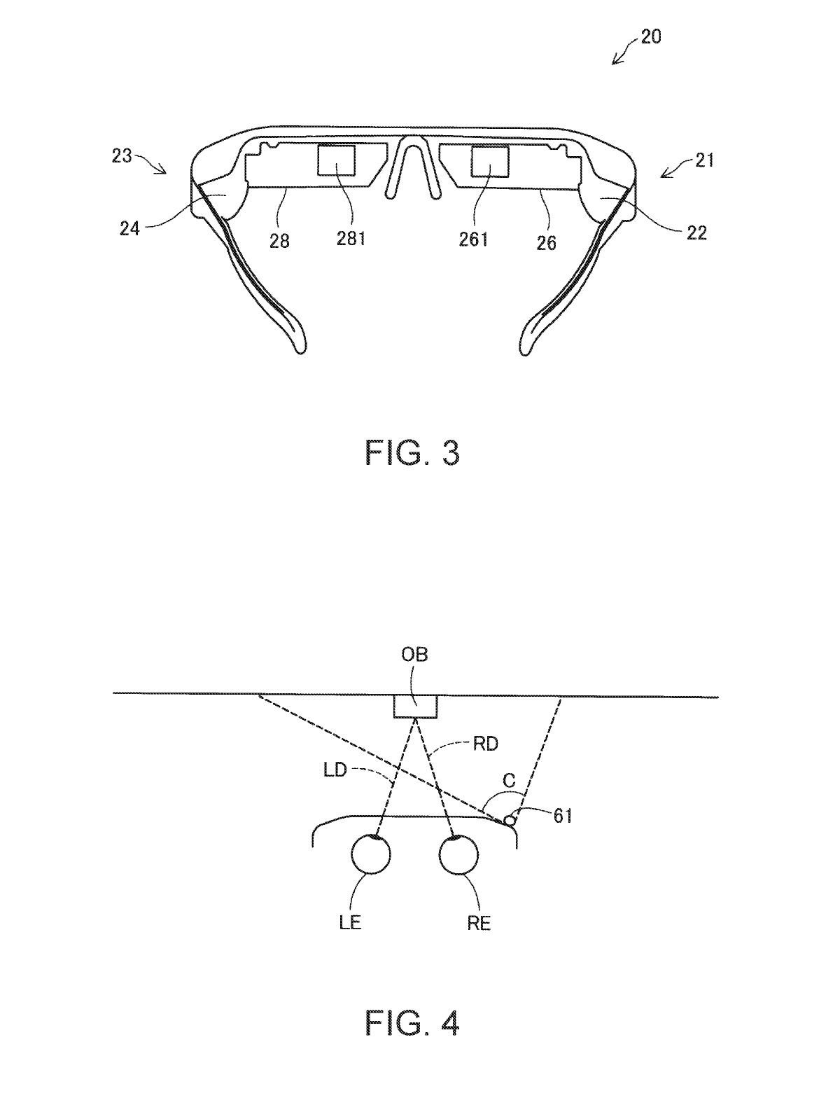

FIG. 3 shows the configuration of key parts of the image display section 20 viewed from the user. In FIG. 3, the connection cable 40, the right earphone 32, and the left earphone 34 are omitted. In the state shown in FIG. 3, the rear side of the right light guide plate 26 and the left light guide plate 28 can be visually recognized, and the half-silvered mirror 261 for irradiating the right eye RE with image light and the half-silvered mirror 281 for irradiating the left eye LE with image light can be visually recognized as roughly quadrangular areas. The user therefore visually recognizes an outside scene through the entire right light guide plate 26 and left light guide plate 28 including the half-silvered mirrors 261 and 281 and further visually recognizes rectangular displayed images in the positions of the half-silvered mirrors 261 and 281.

FIG. 4 describes the angle of view of the camera 61. FIG. 4 diagrammatically shows the camera 61 and the user's right eye RE and left eye LE in a plan view and further shows the angle of view (imaging range) C of the camera 61. It is noted that the actual angle of view C of the camera 61 has a horizontal range, as shown in FIG. 4, and also has a vertical range, as in the case of a typical digital camera.

The camera 61 is disposed in a right end portion of the image display section 20 and performs imaging in the direction of the user's line of sight (that is, captures an image of a space in front of the user), as described above. The optical axis of the camera 61 therefore falls within the range containing the directions of the lines of sight from the right eye RE and the left eye LE. The outside scene visually recognizable by the user on whom the HMD 100 is mounted is not limited to the infinity. For example, when the user gazes at a target object OB with the two eyes, the user's lines of sight are directed toward the target object OB, as indicated by reference characters RD and LD in FIG. 4. In this case, the distance from the user to the target object OB ranges from about 30 cm to 10 m in many instances, and the distance is more likely to range from 1 to 4 m. In view of the fact described above, guideline values of the upper and lower limits of the distance from the user to the target object OB in typical conditions under which the HMD 100 is used may be set. The guideline values may be determined in advance and preset in the HMD 100 or may be set by the user. The optical axis and the angle of view of the camera 61 are preferably so set that the target object OB falls within the angle of view in a case where the distance to the target object OB under the typical use conditions is equal to the set guideline values of the upper and lower limits.

In general, it is believed that a person's angular field of view is about 200 degrees in the horizontal direction and about 125 degrees in the vertical direction. Within these ranges, an effective field of view, where the person has excellent information reception capability, extends over a horizontal range of about 30 degrees and a vertical range of about 20 degrees. It is further believed that a stable field of fixation, where a point of fixation at which the person gazes is viewed in a quick, stable manner, extends over a horizontal range from about 60 to 90 degrees and a vertical range from about 45 to 70 degrees. In this case, when the point of fixation coincides with the target object OB (FIG. 4), the effective field of view extends over the horizontal range of about 30 degrees and the vertical range of about 20 degrees around the lines of sight RD and LD. The stable field of fixation extends over the horizontal range from about 60 to 90 degrees and the vertical range from about 45 to 70 degrees around the lines of sight RD and LD. The actual field of view visually recognized by the user through the image display section 20 and further through the right light guide plate 26 and the left light guide plate 28 is called an actual field of view (FOV). The actual field of view is narrower than the angular field of view and the stable field of fixation but wider than the effective field of view.

The angle of view C of the camera 61 in the present embodiment is so set as to allow imaging over a range wider than the user's field of view. The angle of view C of the camera 61 is preferably so set as to allow imaging over a range at least wider than the user's effective field of view and is more preferably so set as to allow imaging over a range wider than the actual field of view. The angle of view C of the camera 61 is further preferably so set as to allow imaging over a range wider than the user's stable field of fixation and is most preferably so set as to allow imaging over a range wider than the user's binocular angular field of view. To this end, the camera 61 may include what is called a wide-angle lens as the imaging lens for imaging over a wide angle of view. The wide-angle lens may include a lens called a super-wide-angle lens or a semi-wide-angle lens. The camera 61 may include a fixed-focal-length lens, a zoom lens, or a lens group formed of a plurality of lenses.

FIG. 5 is a functional block diagram of the configuration of the HMD 100. The control apparatus 10 includes a main processor 140, which executes a program to control the HMD 100, a storage section, an input/output section, a variety of sensors, an interface, and a power supply section 130. The storage section, the input/output section, the variety of sensors, the interface, and the power supply section 130 are connected to the main processor 140. The main processor 140 is mounted on a controller substrate 120 built in the control apparatus 10.

The storage section includes a memory 118 and a nonvolatile storage section 121. The memory 118 forms a work area that temporarily stores a computer program executed by the main processor 140 and data processed by the main processor 140. The nonvolatile storage section 121 is formed of a flash memory or an eMMC (embedded multimedia card). The nonvolatile storage section 121 stores the computer program executed by the main processor 140 and a variety of data processed by the main processor 140. In the present embodiment, these storage sections are mounted on the controller substrate 120.

The input/output section includes the trackpad 14 and an operation section 110. The operation section 110 includes the buttons 11, the LED indicator 12, the cross key 13, the trackpad 14, the up/down keys 15, the changeover switch 16, and the power switch 18 described above. The main processor 140 controls these input/output sections described above and acquires signals outputted from the input/output sections.

The variety of sensors include a six-axis sensor 111, a magnetic sensor 113, and a GPS (global positioning system) 115. The six-axis sensor 111 is a motion sensor (inertia sensor) including a three-axis acceleration sensor and a three-axis gyro (angular velocity) sensor. The six-axis sensor 111 may be an IMU (inertial measurement unit) formed of the sensors described above as a modular part. The magnetic sensor 113 is, for example, a three-axis geomagnetic sensor. The GPS 115 includes a GPS antenna that is not shown and receives wireless signals transmitted from GPS satellites to detect the coordinates of the current position of the control apparatus 10. The variety of sensors (six-axis sensor 111, magnetic sensor 113, and GPS 115) output detection values to the main processor 140 in accordance with sampling frequencies specified in advance. Each of the sensors may instead output a detection value at a point of time according to an instruction from the main processor 140.

The interface includes a communication section 117, a voice codec 180, an external connector 184, an external memory interface 186, a USB (universal serial bus) connector 188, a sensor hub 192, an FPGA 194, and an interface 196. Each of these components functions as an interface with an external apparatus. The communication section 117 performs wireless communication between the HMD 100 and an external apparatus. The communication section 117 includes an antenna, an RF circuit, a baseband circuit, a communication control circuit, and other components that are not shown or is formed as a device formed of the above components integrated with one another. The communication section 117 performs wireless communication that complies, for example, with a wireless LAN standard including Bluetooth (registered trademark) and Wi-Fi (registered trademark).

The voice codec 180 is connected to the voice interface 182 and decodes/encodes a voice signal inputted and outputted via the voice interface 182. The voice interface 182 is an interface via which a voice signal is inputted and outputted. The voice codec 180 may include an A/D converter that converts an analog voice signal into digital voice data and a D/A converter that performs conversion in the opposite direction. The HMD 100 in the present embodiment outputs voice through the right earphone 32 and the left earphone 34 and collects sound via the microphone 63. The voice codec 180 converts digital voice data outputted from the main processor 140 into an analog voice signal and outputs the analog voice signal via the voice interface 182. The voice codec 180 further converts an analog voice signal inputted to the voice interface 182 into digital voice data and outputs the digital voice data to the main processor 140.

The external connector 184 is a connector that connects an external apparatus (personal computer, smartphone, and game console, for example) that communicates with the main processor 140 to the main processor 140. The external apparatus connected to the external connector 184 can be a content supply source and can also be used to debug the computer program executed by the main processor 140 and collect action logs of the HMD 100. The external connector 184 can be implemented in a variety of aspects. Examples of the external connector 184 can be a USB interface, a micro USB interface, a memory card interface, or any other interface corresponding to wired connection, or a wireless LAN interface, a Bluetooth interface, or any other interface corresponding to wireless connection.

The external memory interface 186 is an interface that allows connection to a portable memory device. The external memory interface 186 includes, for example, a memory card slot into which a card-shaped recording medium is inserted and via which data is read and written and an interface circuit. The size, shape, standard, and other factors of the card-shaped recording medium can be selected as appropriate. The USB connector 188 is an interface that allows connection to a memory device, a smartphone, a personal computer, and other devices that comply with a USB standard. The USB connector 188 includes, for example, a connector that complies with the USB standard and an interface circuit. The size, shape, USB standard version, and other factors of the USB connector 188 can be selected as appropriate.

The HMD 100 further includes a vibrator 19. The vibrator 19 includes a motor, an off-center rotator, and other components that are not shown and produces vibration under the control of the main processor 140. The HMD 100 causes the vibrator 19 to produce vibration in a predetermined vibration pattern, for example, when operation performed on the operation section 110 is detected or when the HMD 100 is powered on and off.

The sensor hub 192 and the FPGA 194 are connected to the image display section 20 via the interface (I/F) 196. The sensor hub 192 acquires detection values from the variety of sensors provided in the image display section 20 and outputs the detection values to the main processor 140. The FPGA 194 processes data transmitted from the main processor 140 and received by the portions of the image display section 20 and vice versa and transports the processed data via the interface 196. The interface 196 is connected to the right display unit 22 and the left display unit 24 of the image display section 20. In the example of the present embodiment, the connection cable 40 is connected to the left holder 23, and a wiring line that leads to the connection cable 40 is routed in the image display section 20, whereby the right display unit 22 and the left display unit 24 are connected to the interface 196 of the control apparatus 10.

The power supply section 130 includes a battery 132 and a power supply control circuit 134. The power supply section 130 supplies electric power that allows the control apparatus 10 to operate. The battery 132 is a chargeable cell. The power supply control circuit 134 detects the amount of remaining electric power in the battery 132 and controls electric charging to the battery 132. The power supply control circuit 134 is connected to the main processor 140 and outputs a detection value representing the amount of remaining electric power in the battery 132 and a detection value representing the voltage across the battery 132 to the main processor 140. Electric power may further be supplied from the control apparatus 10 to the image display section 20 on the basis of the electric power supplied from the power supply section 130. The main processor 140 may be configured to be capable of controlling the state of electric power supply from the power supply section 130 to the portions of the control apparatus 10 and the image display section 20.

The right display unit 22 includes a display unit substrate 210, the OLED unit 221, the camera 61, an illuminance sensor 65, an LED indicator 67, and the temperature sensor 217. On the display unit substrate 210 are mounted an interface (I/F) 211 connected to the interface 196, a receiver (Rx) 213, and an EEPROM (electrically erasable programmable read-only memory) 215. The receiver 213 receives data inputted from the control apparatus 10 via the interface 211. The receiver 213, when it receives image data on an image to be displayed by the OLED unit 221, outputs the received image data to the OLED drive circuit 225 (FIG. 2).

The EEPROM 215 stores a variety of types of data in a form readable by the main processor 140. The EEPROM 215 stores, for example, data on light emission characteristics and display characteristics of the OLED units 221 and 241 of the image display section 20, data on sensor characteristics of the right display unit 22 or the left display unit 24, and other types of data. Specifically, for example, the EEPROM 215 stores a parameter relating to correction of the gamma values of the OLED units 221 and 241, data used to compensate detection values from the temperature sensors 217 and 239, which will be described later, and other types of data. The data described above are produced when the HMD 100 is inspected just before the HMD 100 is shipped from the factory and written onto the EEPROM 215. After the shipment, the main processor 140 reads the data in the EEPROM 215 and uses the data in a variety of processes.

The camera 61 performs the imaging in accordance with a signal inputted via the interface 211 and outputs captured image data or a signal representing an imaging result to the control apparatus 10. The illuminance sensor 65 is provided at the end ER of the front frame 27 and so disposed as to receive outside light from a space in front of the user on whom the image display section 20 is mounted, as shown in FIG. 1. The illuminance sensor 65 outputs a detection value corresponding to the amount of received light (intensity of received light). The LED indicator 67 is disposed at the end ER of the front frame 27 and in the vicinity of the camera 61, as shown in FIG. 1. The LED indicator 67 illuminates when the camera 61 is performing imaging to notify the user that the imaging is underway.

The temperature sensor 217 detects temperature and outputs a voltage value or a resistance value corresponding to the detected temperature. The temperature sensor 217 is mounted on the rear side of the OLED panel 223 (FIG. 2). The temperature sensor 217 may be mounted, for example, on the substrate on which the OLED drive circuit 225 is mounted. In the configuration described above, the temperature sensor 217 primarily detects the temperature of the OLED panel 223. The temperature sensor 217 may instead be built in the OLED panel 223 or the OLED drive circuit 225. For example, in a case where the OLED panel 223 is implemented as an Si-OLED, along with the OLED drive circuit 225, in the form of an integrated circuit on a unified semiconductor chip, the temperature sensor 217 may be mounted on the semiconductor chip.

The left display unit 24 includes a display unit substrate 230, the OLED unit 241, and a temperature sensor 239. On the display unit substrate 230 are mounted an interface (I/F) 231 connected to the interface 196, a receiver (Rx) 233, a six-axis sensor 235, and a magnetic sensor 237. The receiver 233 receives data inputted from the control apparatus 10 via the interface 231. The receiver 233, when it receives image data on an image to be displayed by the OLED unit 241, outputs the received image data to the OLED drive circuit 245 (FIG. 2).

The six-axis sensor 235 is a motion sensor (inertia sensor) including a three-axis acceleration sensor and a three-axis gyro (angular velocity) sensor. The six-axis sensor 235 may be an IMU having the sensors described above as a modular part. The magnetic sensor 237 is, for example, a three-axis geomagnetic sensor. The temperature sensor 239 detects temperature and outputs a voltage value or a resistance value corresponding to the detected temperature. The temperature sensor 239 is mounted on the rear side of the OLED panel 243 (FIG. 2). The temperature sensor 239 may be mounted, for example, on the substrate on which the OLED drive circuit 245 is mounted. In the configuration described above, the temperature sensor 239 primarily detects the temperature of the LED panel 243. The temperature sensor 239 may instead be built in the OLED panel 243 or the OLED drive circuit 245. Details of the temperature sensor 239 are the same as those of the temperature sensor 217.

The camera 61, the illuminance sensor 65, and the temperature sensor 217 of the right display unit 22, and the six-axis sensor 235, the magnetic sensor 237, and the temperature sensor 239 of the left display unit 24 are connected to the sensor hub 192 of the control apparatus 10. The sensor hub 192 sets and initializes, under the control of the main processor 140, the sampling cycle in accordance with which each of the sensors performs detection. The sensor hub 192, for example, conducts electricity to each of the sensors, transmits control data thereto, and acquires a detection value therefrom in accordance with the sampling cycle in accordance with which the sensor performs detection. The sensor hub 192 outputs detection values from the sensors provided in the right display unit 22 and the left display unit 24 at preset timing to the main processor 140. The sensor hub 192 may have a cache function of temporarily holding the detection values from the sensors. The sensor hub 192 may have the function of converting the signal format and data format of the detection values from the sensors (function of converting different formats into a unified format, for example). The sensor hub 192 starts and stops conducting electricity to the LED indicator 67 under the control of the main processor 140 to turn on and off the LED indicator 67.

FIG. 6 is a functional block diagram showing the configuration of a control function section of the HMD 100. The control function section of the HMD 100 includes a storage section 122 and the control section 150. The storage section 122 is a logical storage section formed of the nonvolatile storage section 121 (FIG. 5). FIG. 6 shows an example in which only the storage section 122 is used, and the nonvolatile storage section 121 may be combined with the EEPROM 215 and the memory 118 and used as the storage section 122. The control section 150 is achieved when the main processor 140 executes the computer program, that is, when the hardware and the software cooperate with each other.

The storage section 122 stores a variety of data used in processes carried out by the control section 150. Specifically, the storage section 122 in the present embodiment stores setting data 123 and content data 124. The setting data 123 contains a variety of setting values associated with the action of the HMD 100. For example, the setting data 123 contains a parameter, a determinant, an arithmetic expression, an LUT (lookup table), and other factors used when the control section 150 controls the HMD 100.

The content data 124 contains data on contents containing still images and video images to be displayed by the image display section 20 under the control of the control section 150 (such as still image data, video image data, and voice data). The content data 124 may contain data on bidirectional contents. A bidirectional content means a content that causes the control apparatus 10 to acquire the user's operation, causes the control section 150 to carry out a process according to the acquired operation, and causes the image display section 20 to display a content according to the process. In this case, the content data may contain image data on a menu screen for acquiring the user's operation, data that specifies a process corresponding to each item contained in the menu screen, and other types of data.

The control section 150 uses the data stored in the storage section 122 to carry out a variety of processes to perform the functions of the OS 143, an image processing section 145, a display control section 147, an imaging control section 149, and an input/output control section 151. In the present embodiment, each of the functional sections excluding the OS 143 is achieved by an application program run on the OS 143.

The image processing section 145 produces signals to be transmitted to the right display unit 22 and the left display unit 24 on the basis of image data on still images/video images to be displayed by the image display section 20. The signals produced by the image processing section 145 may be a vertical sync signal, a horizontal sync signal, a clock signal, an analog image signal, and other signals. The image processing section 145 is not necessarily achieved by the computer program executed by the main processor 140 and may instead be achieved by hardware (DSP (digital signal processor), for example) separate from the main processor 140.

The image processing section 145 may carry out a resolution conversion process, an image adjustment process, a 2D/3D conversion process, and other processes as required. The resolution conversion process is a process of converting the resolution of the image data into resolution suitable for the right display unit 22 and the left display unit 24. The image adjustment process is a process of adjusting the luminance and chroma of the image data. The 2D/3D conversion process is a process of creating 2D image data from 3D image data or creating 3D image data from 2D image data. Having performed the processes described above, the image processing section 145 produces signals for displaying images on the basis of the processed image data and transmits the signals to the image display section 20 via the connection cable 40.

The display control section 147 produces control signals that control the right display unit 22 and the left display unit 24, and the control signals control the right display unit 22 and the left display unit 24 to cause them to each produce and output image light. Specifically, the display control section 147 controls the OLED drive circuits 225 and 245 to cause them to display images on the OLED panels 223 and 243. The display control section 147 controls the timing at which the OLED drive circuits 225 and 245 draw images on the OLED panels 223 and 243, controls the luminance of the OLED panels 223 and 243, and performs other types of control on the basis of the signals outputted from the image processing section 145.

The imaging control section 149 controls the camera 61 to cause it to perform imaging for generation of captured image data and controls the storage section 122 to cause it to temporarily store the data. In a case where the camera 61 is configured as a camera unit including a circuit that produces captured image data, the imaging control section 149 acquires the captured image data from the camera 61 and temporarily stores the data in the storage section 122.

The input/output control section 151 acquires a result of detection of the on/off state of each button of the cross key 13. In a case where the result of the detection contains a pre-specified pattern (which will be described later in detail) at the time of transition to a flick input mode in which flick input is performed, the input/output control section 151 performs output corresponding to the flick input. In a typical input mode in which no flick input is performed, the input/output control section 151 directly outputs a result of the on/off detection. The transition to the flick input mode occurs when an instruction from the OS 143 or an application program is received. For example, at the time of transition to a task associated with a Japanese letter input field, the input/output control section 151 receives, from the OS 143 or an application program, an instruction representing transition to the flick input mode. The destination to which the flick input or a result of the on/off detection is outputted can be arbitrarily specified and is the OS 143 in the present embodiment. The input/output control section 151 may instead output the flick input or a result of the on/off detection, in place of the OS 143 or in addition thereto, an application program that runs on the OS 143. An application program that runs on the OS 143 is an application program installed in the display control section 147, in the imaging control section 149, or on the OS 143.

The input/output control section 151 may output the flick input or a result of the on/off detection to the image display section 20 connected via the interface 196 or to an external apparatus connected via the external connector 184. In this case, the flick input detection or a result of the on/off detection is used by a control section incorporated in the image display section 20 or a control section of the external apparatus.

### A-2. Configuration of Cross Key:

FIG. 7 describes the cross key 13. In the HMD 100 in the present embodiment, the cross key 13 can be used to perform flick input. The cross key 13 in the present embodiment is formed of one finalizing button 139 and four direction buttons 135 to 138 corresponding to the upward, downward, rightward, and leftward directions. The finalizing button 139 has a circular shape, and each of the direction buttons 135 to 138 has a rectangular shape. These buttons have what is called a cross key aspect in which the finalizing button 139 and the four direction buttons 135 to 138 are arranged on the surface of the enclosure of the control apparatus 10 with the finalizing button 139 located at the center and the four direction buttons 135 to 138 located in the upward, downward, rightward, and leftward positions with respect to the finalizing button 139. In the following sections, when the four direction buttons 135 to 138 are collectively described, they are simply called “direction buttons,” and when they are individually described, they are called a left button 135, a right button 136, an upper button 137, and a lower button 138. In FIG. 7, letters “Finalize,” “Up,” “Down,” “Left,” and “Right” are written for convenience, but these letters are not necessarily displayed on the actual cross key 13 or may be replaced, for example, with symbols.

The finalizing button 139 in the present embodiment is what is called a mechanical-contact button so configured that when the user presses the finalizing button 139, a switch provided therein is turned on, whereas when the user stops pressing the finalizing button 139, the internal switch is turned off. On the other hand, each of the four direction buttons 135 to 138 is what is called a capacitance button so configured that when the user touches the direction button, a switch provided therein is turned on, whereas when the user releases the direction button, the internal switch is turned off. The configuration of each of the finalizing button 139 and the direction buttons is presented only by way of example, and any of a variety of other aspects can be employed. For example, each of the finalizing button 139 and the direction buttons may be a mechanical-contact button or a capacitance button.

As described above, according to the input apparatus (control apparatus 10) of the present embodiment, the finalizing button 139 and the direction buttons 135 to 138 can be configured as the cross key 13, which is readily understood and operated by the user in an intuitive manner. Further, the input apparatus can be configured by use of either a mechanical-contact button or a capacitance button.

### A-3. Input/Output Control (Generic Example):

A description will be made of a generic example of the flick input by use of the input/output control section 151.

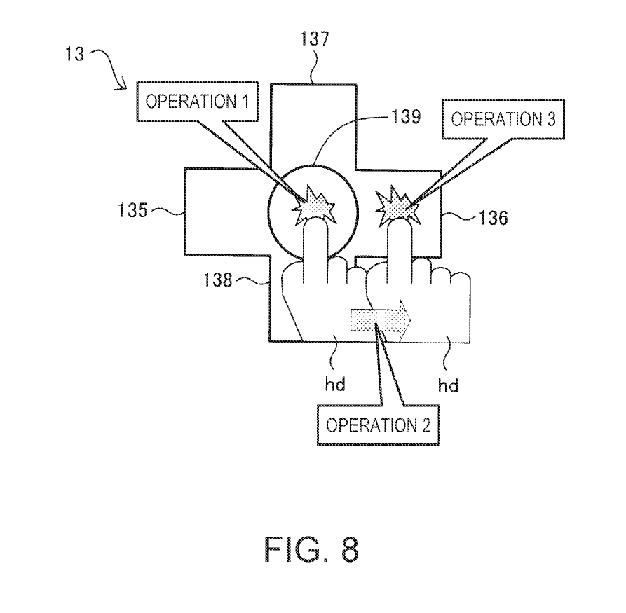

FIG. 8 describes a flick input method using the cross key 13. In FIG. 8, the description will be made of a right flick by way of example.

(1) The user first uses a finger of a hand hd to press the finalizing button 139 and then stops pressing the finalizing button 139. In the present embodiment, the user's operation of pressing the finalizing button 139 and then releasing the finalizing button 139 is also called “operation 1.” The operation 1 allows the input/output control section 151 to acquire the on/off state of the finalizing button 139.

(2) The user then moves the hand hd to the position of the right button 136 (arrow in FIG. 8). In the present embodiment, the user's operation of moving the hand to a direction button is also called “operation 2.”

(3) The user finally uses the finger of the hand hd to touch the right button 136. In the present embodiment, the user's operation of touching a direction button is also called “operation 3.” The operation 3 allows the input/output control section 151 to acquire the on state of the right button 136.

The consecutive operation 1 to operation 3 function as a “pre-specified pattern.”

The operation 1 allows the input/output control section 151 to acquire the on/off state of the finalizing button 139, and the operation 3 allows the input/output control section 151 to acquire the on state of the right button 136 (direction button). In the case where the on/off state of the finalizing button 139 is detected and the on state of any one of the direction buttons is detected as described above, the input/output control section 151 performs output corresponding to the flick input to the OS 143. The output corresponding to the flick input can have a variety of aspects to the extent that a receiver (OS 143 in the present embodiment) can interpret the output as an action representing that “flick input has been performed.” For example, the input/output control section 151 can perform the following output a1 or a2.

(a1) produce a flick event

(a2) produce a series of events that allow the receiver to detect flick input (see the following, for example)

setting an imaginary touch panel

producing a touched event, for example, getAction (ACTION_DOWN) on the imaginary touch panel

producing a touched, moving event, for example, getAction (ACTION_MOVE) on the imaginary touch panel

producing a disengaged event, for example, getAction (ACTION_UP) on the imaginary touch panel

The input/output control section 151 can, as required, set pre-specified dummy values of a variety of states of touch events (such as X coordinate, Y coordinate, the number of fingers that touch event, pressure of touch action, and period for which touch action is performed).

The user may use a touch pen or any other tool to press a button in place of a finger of the hand hd. In the description of the example described above, the finalizing button 139, which is a mechanical-contact button, is “pressed,” and the four direction buttons 135 to 138, each of which is a capacitance button, are “touched.” The user's operation (pressing/touching) can be changed as appropriate in accordance with the configuration of each of the buttons 135 to 139 (mechanical-contact type/capacitance type). The input/output control section 151 may perform output corresponding to flick input as long as a result of the detection of the on/off state of each of the buttons 135 to 139 contains the pre-specified pattern (operation 1 to 3). Therefore, for example, in a case where the operation 3 is followed by another type of operation, or even in a case where the operation 1 is preceded by another type of operation, the input/output control section 151 can perform output corresponding to the flick input.

As described above, according to the input apparatus (control apparatus 10) of the embodiment described above, in a case where at least two buttons each of which can have an input-on state and an input-off state (buttons 135 to 139) are used and a result of the detection of the states of the buttons contains a pre-specified pattern (operation 1 to 3), the output a1 or a2 corresponding to the flick input is performed. Specifically, when the finalizing button 139 is pressed (or touched) and any one of the four direction buttons 135 to 138 is then pressed (or touched), in other words, in response to movement of a finger before and after pressing/touching actions, the output a1 or a2 corresponding to the flick input is performed. As a result, the user can perform flick input by using the cross key 13 without using any sensor device that can acquire the trajectory of a finger or any other object but through a finger movement action that mimics an actual flick action. Further, in the present example, since the output a1 or a2 is outputted to the OS 143, for example, in the form of an event, a receiver application program can use the output for a variety of purposes.

### A-4. Input/Output Control (Example of Japanese Input):

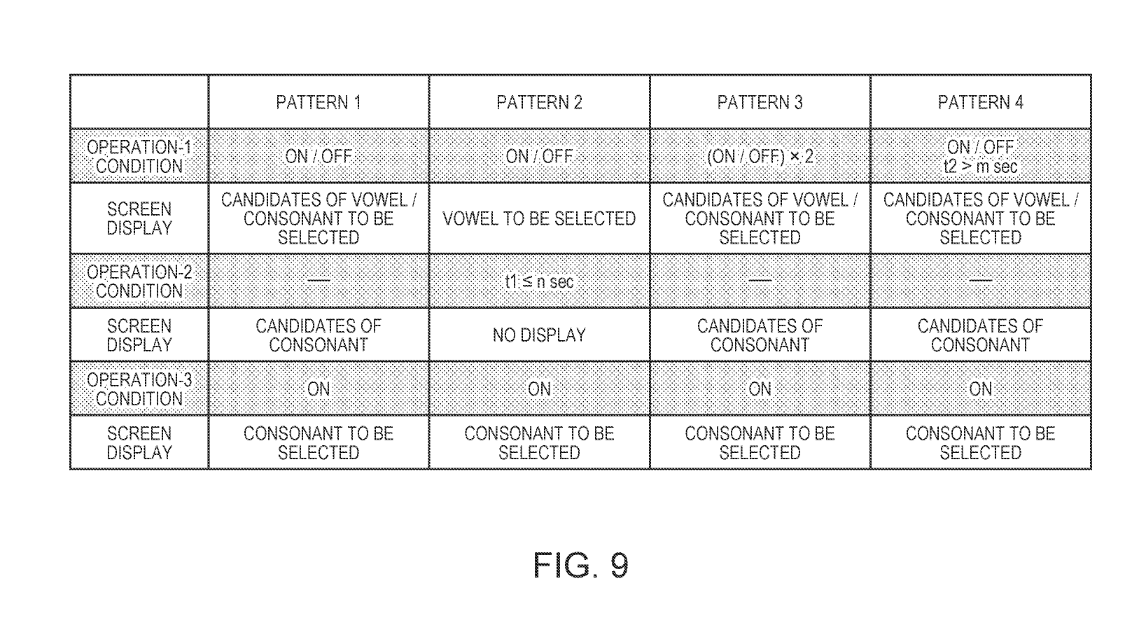

A description will be made of an example in which flick input using the input/output control section 151 is used as a Japanese input method. Japanese input is performed by coordinated action of the input/output control section 151 and the OS 143. FIG. 9 shows examples of the operation pattern that causes the control apparatus 10 to perform output corresponding to flick input. Patterns 1 to 4 in FIG. 9 each function as the “pre-specified pattern.” Each of the patterns in FIG. 9 can also be used in the input/output control described above (generic example). In the case where each of the patterns in FIG. 9 is used in the input/output control (generic example), the “screen display” in FIG. 9 is not required.

### Pattern 1

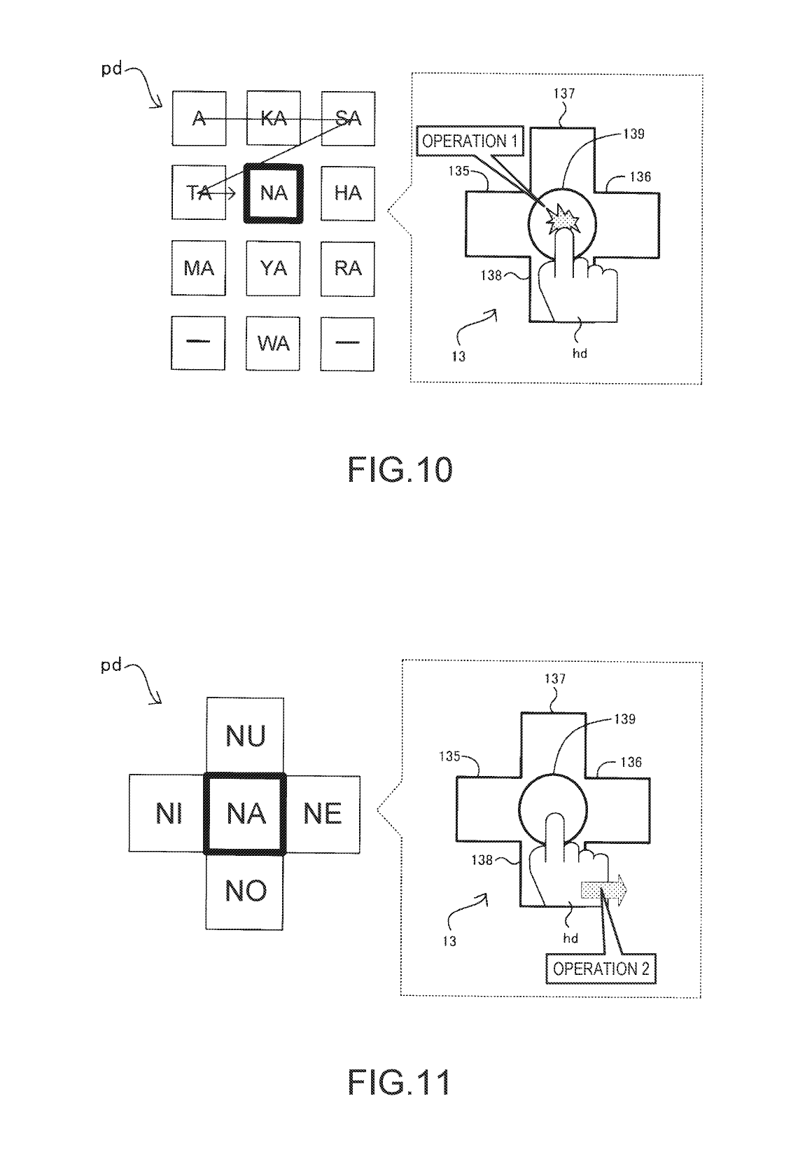

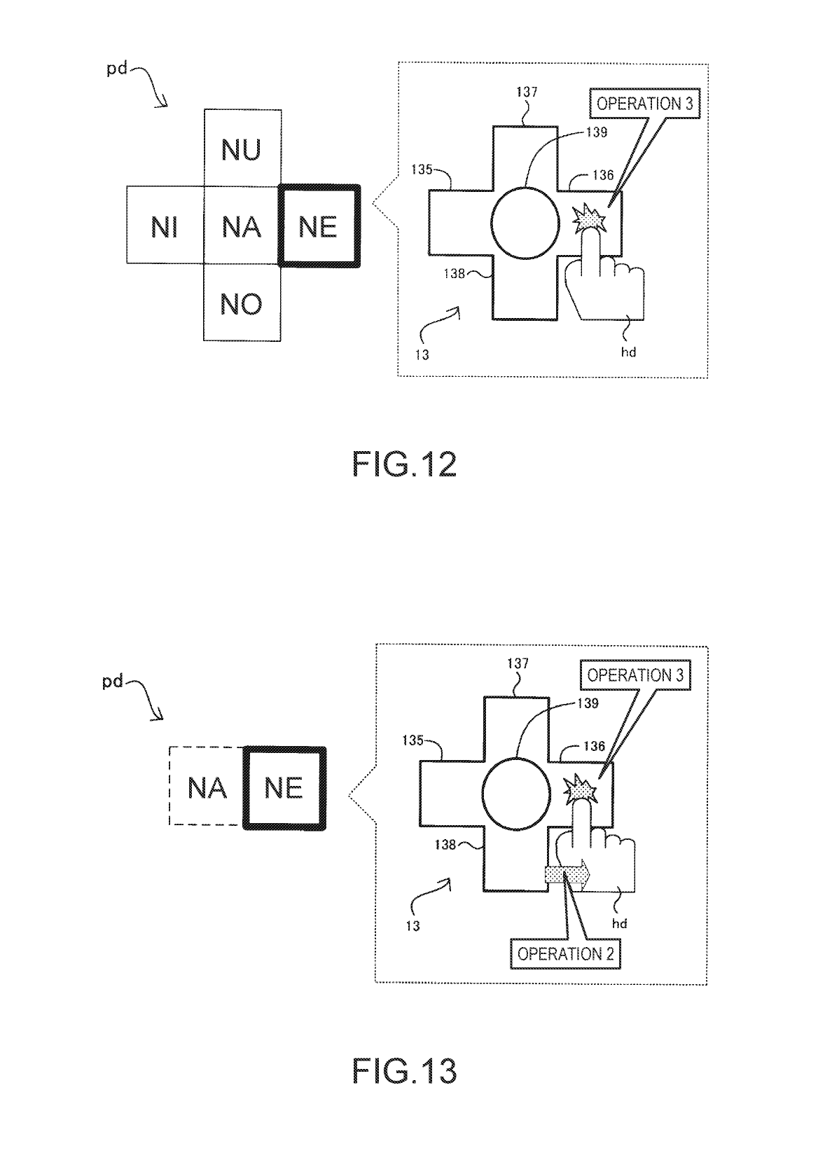

FIG. 10 describes the operation 1 in the pattern 1. FIG. 11 describes the operation 2 in the pattern 1. FIG. 12 describes the operation 3 in the pattern 1. The OS 143 first causes the image display section 20 to display a software keyboard pd (left in FIG. 10). The software keyboard pd has Japanese letters from “a” to “wa” arranged in a tiled pattern, and the letters stand for candidates in the “a” row in the Japanese syllabary. In an initial state, the letter “a” is surrounded with a thick rectangle, which means that the letter “a” is selected. The user touches a direction button of the cross key 13 to move the thick rectangle from the initial candidate in the “a” row in the syllabary on the software keyboard pd to a desired candidate so that the desired candidate is selected. In the example shown in FIG. 10, the letter “na” is selected.

The user uses a finger of the hand hd to press the finalizing button 139 and then stops pressing the finalizing button 139 (operation 1 in FIG. 10). The operation 1 allows the input/output control section 151 to acquire the on/off state of the finalizing button 139. At this point, the input/output control section 151 determines that the “operation-1 condition” in the pattern 1 shown in FIG. 9 has been satisfied and outputs an event representing that the operation-1 condition has been satisfied. The OS 143 having received the event enhances the selected candidate “na” and displays candidates of consonants “ni to no” relating to the selected candidate “na” (left in FIG. 11) on the software keyboard pd displayed by the image display section 20. In FIG. 11 and the following figures, the non-selected “a” row in the syllabary is not displayed for ease of illustration.

The user moves the hand hd to the position of the direction button representing a consonant the user desires to select (operation 2 in FIG. 11). In this process, the OS 143 keeps displaying the consonant candidate on the software keyboard pd.

The user uses the finger of the hand hd to touch the direction button (right button 136 in the example shown in FIG. 12) (operation 3 in FIG. 12). The operation 3 allows the input/output control section 151 to acquire the on state of the right button 136. At this point, the input/output control section 151 determines that the “operation-3 condition” in the pattern 1 shown in FIG. 9 has been satisfied and outputs an event representing that the operation-3 condition has been satisfied. The OS 143 having received the event enhances the selected consonant “ne” on the software keyboard pd displayed by the image display section 20 (left in FIG. 12). Further, the OS 143 outputs the selected consonant “ne” as the output corresponding to the flick input. As a result, the letter “ne” is displayed, for example, on a letter input pad. As described above, in the present example, in which flick input is used in a Japanese input method, a finally selected letter is outputted as the output corresponding to the flick input in place of the output a1 or a2 described above.

### Pattern 2

FIG. 13 describes the operation 2 and operation 3 in the pattern 2. The OS 143 causes the image display section 20 to display the software keyboard pd. The details in FIG. 13 are the same as those in FIG. 10. The user touches a direction button of the cross key 13 to move the thick rectangle from the initial candidate in the “a” row in the syllabary on the software keyboard pd to a desired candidate so that the desired candidate is selected.

The user uses the finger of the hand hd to press the finalizing button 139 and then stops pressing the finalizing button 139 (operation 1 in FIG. 10). The operation 1 allows the input/output control section 151 to acquire the on/off state of the finalizing button 139. At this point, the input/output control section 151 determines that the “operation-1 condition” in the pattern 2 shown in FIG. 9 has been satisfied and outputs the event representing that the operation-1 condition has been satisfied. The OS 143 having received the event enhances the selected candidate “na” on the software keyboard pd displayed by the image display section 20. In the present example, no consonant candidate is displayed.

The user moves the hand hd to the position of the direction button representing a consonant the user desires to select (operation 2 in FIG. 13).

The user uses the finger of the hand hd to touch a direction button (right button 136 in the example shown in FIG. 13) (operation 3 in FIG. 13). The operation 3 allows the input/output control section 151 to acquire the on state of the right button 136. The input/output control section 151 then evaluates whether or not a period t1 (sec) from the timing of the acquisition of the off state of the finalizing button 139 in the operation 1 to the timing of the acquisition of the on state of the direction button in the operation 3 is shorter than or equal to a predetermined period n (sec). The predetermined period n functions as a “first period”, is specified in advance, and is stored in the storage section 122. The predetermined period n can be arbitrarily specified and is preferably set to be a short period to some extent in consideration of a typical finger movement period in flick operation. In the case where the period t1 is shorter than or equal to the predetermined period n, the input/output control section 151 determines that the “operation-2 condition” in the pattern 2 shown in FIG. 9 has been satisfied.

Further, since the operation 3 has allowed the input/output control section 151 to acquire the on state of the right button 136, the input/output control section 151 determines that the “operation-3 condition” in the pattern 2 shown in FIG. 9 has also been satisfied. The input/output control section 151 then outputs an event representing that the operation-2 condition and the operation-3 condition have been satisfied. The OS 143 having received the event displays and enhances the selected consonant “ne” on the software keyboard pd displayed by the image display section 20 (left in FIG. 13). Further, the OS 143 outputs the selected consonant “ne.”

According to the input/output control using the pattern 2, the consonant “ne” selected by the flick input is outputted only in the case where the period (t1) between the timing of the pressing (or touching) operation of the finalizing button 139 and the timing of pressing (or touching) operation of any of the direction buttons 135 to 138 is shorter than or equal to the first period (n). Appropriately setting the first period allows the user to properly use the following two types of operation: typical finalization-direction input using the cross key 13; and flick input as a Japanese input method.

### Pattern 3

The pattern 3 is the same as the pattern 1 except that the input/output control section 151 evaluates the “operation-1 condition” by using a different reference. In a case where the user repeats pressing operation of the finalizing button 139 twice in the pattern 3, in other words, in a case where the input/output control section 151 acquires the on/off state of the finalizing button 139 twice in succession, the input/output control section 151 determines that the “operation-1 condition” has been satisfied.

According to the input/output control using the pattern 3, a letter selected by the flick input is outputted only in the case where the finalizing button 139 is pressed (or touched) twice and then any of the direction buttons 135 to 138 is pressed (or touched). The user can therefore properly use the following two types of operation: typical finalization-direction input using the cross key 13; and flick input as a Japanese input method.

### Pattern 4

The pattern 4 is the same as the pattern 1 except that the input/output control section 151 evaluates the “operation-1 condition” by using a different reference. In a case where the user presses the finalizing button 139 for a long period in the pattern 4, in other words, in a case where a period t2 (sec) from the timing of the acquisition of the on state of the finalizing button 139 to the timing of the acquisition of the off state of the finalizing button 139 is longer than a predetermined period m (sec), the input/output control section 151 determines that the “operation-1 condition” has been satisfied. The predetermined period m functions as a “second period,” is specified in advance, and is stored in the storage section 122. The predetermined period m can be arbitrarily specified and is preferably set at a value in consideration of typical long pressing operation of a button.

According to the input/output control using the pattern 4, a selected candidate is enhanced and candidates of consonant relating to the selected candidate are displayed only in the case where the period (t2) from the start of pressing (or touching) operation of the finalizing button 139 to the end of the pressing (or touching) operation of the finalizing button 139 is longer than the second period (m). Appropriately setting the second period allows the user to intentionally use the following two types of operation properly in response to the long pressing operation of the finalizing button 139: typical finalization-direction input using the cross key 13; and flick input as a Japanese input method.

As described above, according to the input apparatus (control apparatus 10) of the embodiment described above, in a case where at least two buttons each of which can have an input-on state and an input-off state (buttons 135 to 139) are used and a result of detection of the states of the buttons contains any of the pre-specified patterns 1 to 4 (operation 1 to 3), a letter selected by the flick input as a Japanese input method is outputted. As a result, the user can perform flick input by using the cross key 13 without using any sensor device that can acquire the trajectory of a finger or any other object but through a finger movement action that mimics an actual flick action.

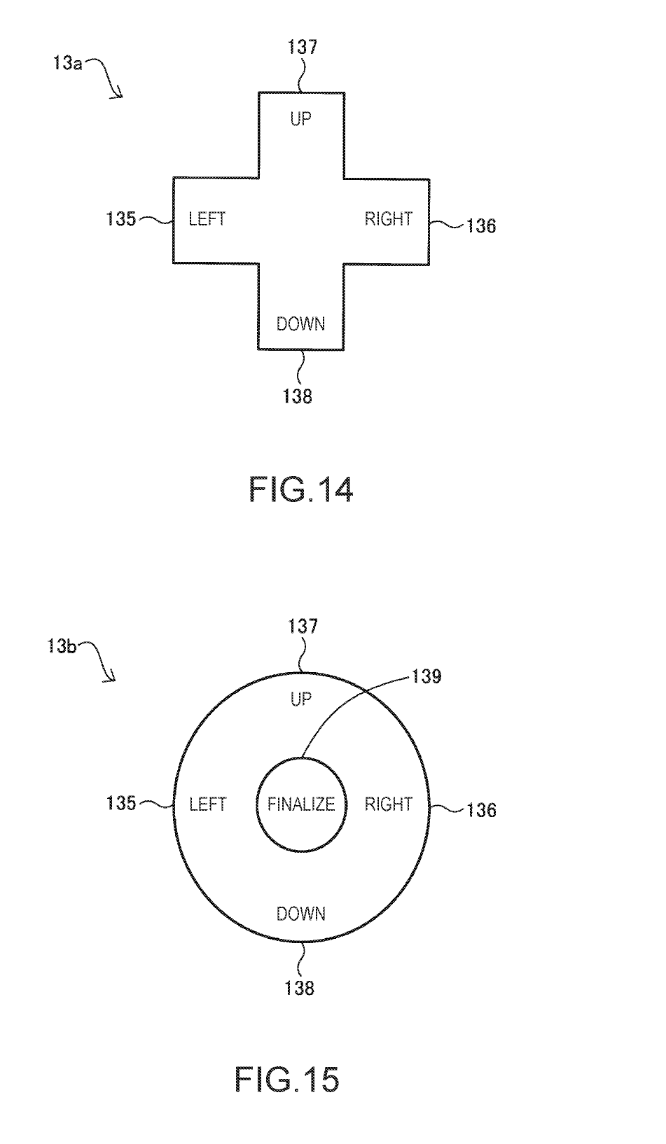

FIG. 14 describes another configuration of the cross key 13. A cross key 13a shown in FIG. 14 is the same as the cross key 13 described above except that the cross key 13a has no finalizing button 139. In a case where the input control described above is performed by use of the thus configured cross key 13a, no finalizing button 139 can be used but any of the other direction buttons may be used. For example, the user touches the left button 135, releases the left button 135, and touches the right button 136. Since the operation described above allows the input/output control section 151 to acquire the on/off state of the left button 135 and the on state of the right button 136, output corresponding to the rightward flick input is performed. Similarly, the user touches the upper button 137, releases the upper button 137, and touches the lower button 138. The operation described above allows the input/output control section 151 to perform output corresponding to the downward flick input. As described above, even in the case where no finalizing button 139 is provided, the input/output control section 151 can perform the same action as that in the embodiment described above as long as at least two direction buttons are provided.

FIG. 15 describes another configuration of the cross key 13. A cross key 13b shown in FIG. 15 is the same as the cross key 13 described above except that the surfaces of the direction buttons 135 to 138 are covered with a circular cover. Use of the thus configured cross key 13b allows the same advantageous effects as those provided by the embodiment described above to be provided.

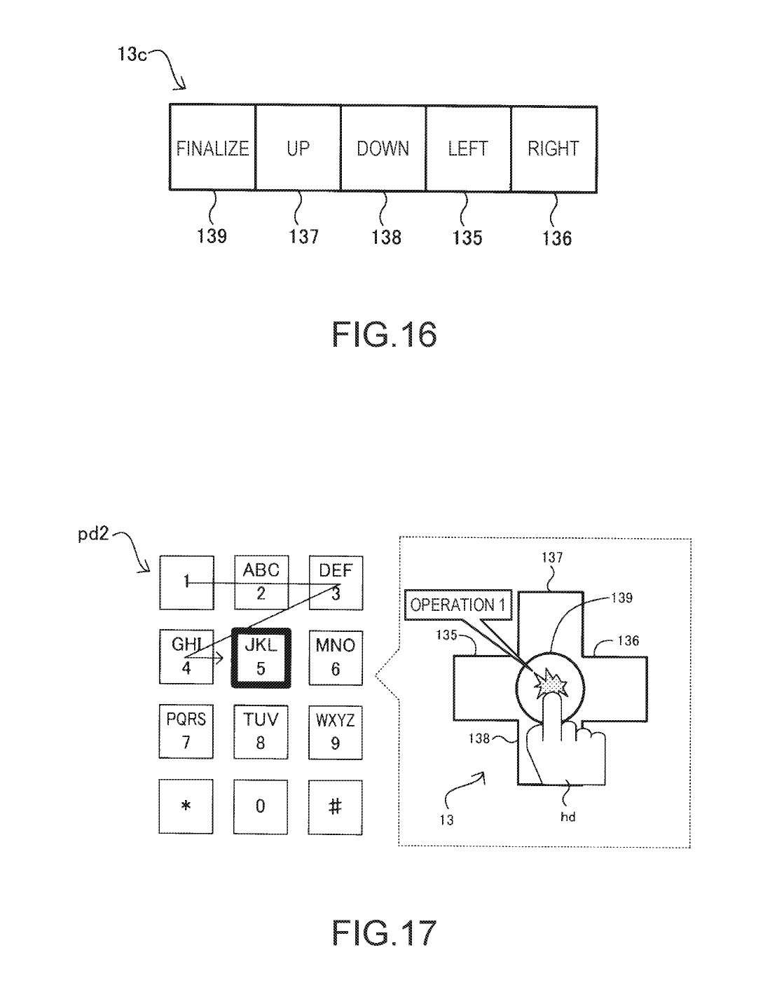

FIG. 16 describes another configuration of the cross key 13. A cross key 13c shown in FIG. 16 is the same as the cross key 13 described above except that the finalizing button 139 has a rectangular shape and the finalizing button 139 and the direction buttons 135 to 138 are arranged along a single row. Use of the thus configured cross key 13c allows the same advantageous effects as those provided by the embodiment described above to be provided.

### B. Second Embodiment

An HMD in a second embodiment of the invention differs from the HMD 100 in the first embodiment in terms of the letter input function achieved by the control apparatus 10. Specifically, in the first embodiment, the control apparatus 10 employs Japanese input as the letter input. In contrast, in the second embodiment, alphabetical letter input is employed as the letter input. The other configurations of the HMD in the second embodiment are the same as those in the first embodiment and will not be described. The same components as those in the first embodiment have the same reference characters as those in the first embodiment in the following description.

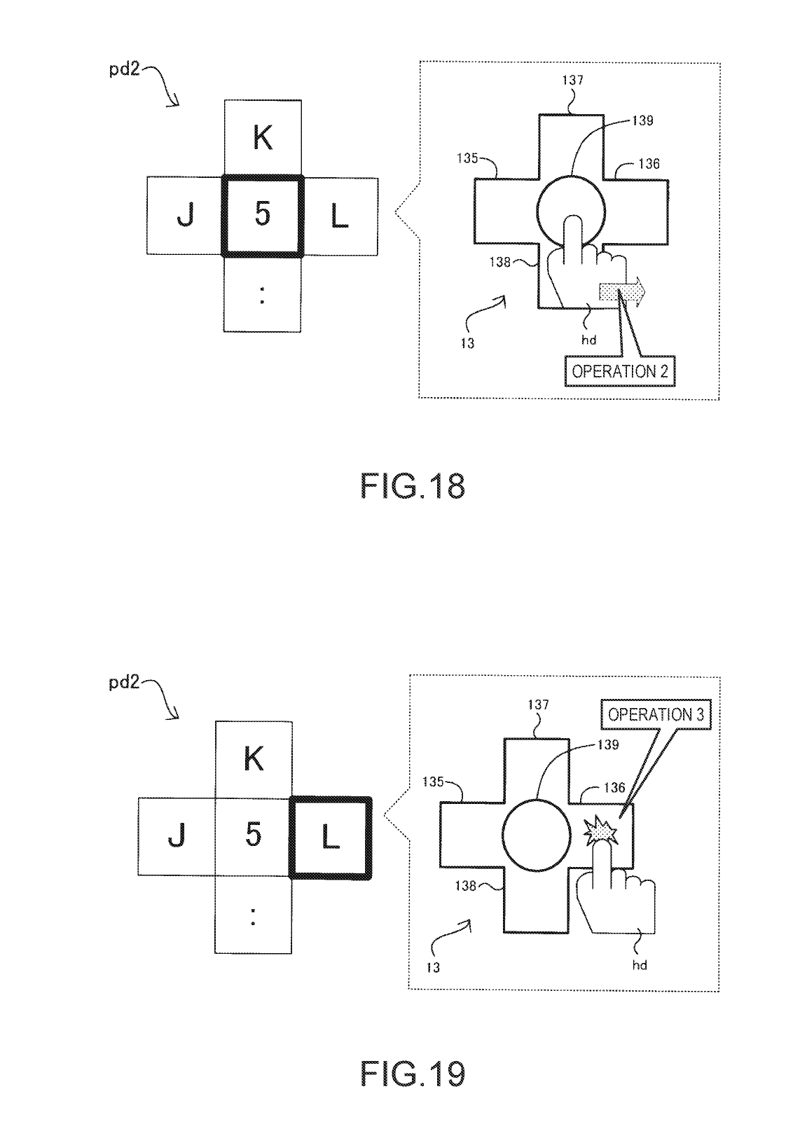

FIGS. 17 to 20 correspond to FIGS. 10 to 13 in the first embodiment. FIG. 17 describes the operation 1 in the pattern 1. FIG. 18 describes the operation 2 in the pattern 1. FIG. 19 describes the operation 3 in the pattern 1.

A software keyboard pd2 in the second embodiment has 12 keys arranged in a tiled pattern (4 rows by 3 columns), and alphabetical letters from “A” to “Z”, numerals from “0” to “9”, and other symbols are assigned to the keys in accordance with a pre-specified rule, as shown in FIG. 17. Specifically, “1” is assigned to the left key in the first row, “A”, “B”, “C”, and “2” are assigned to the center key in the first row, and “D”, “E”, “F”, and “3” are assigned to the right key in the first row. “G”, “H”, “I”, and “4” are assigned to the left key in the second row, “J”, “K”, “L”, and “5” are assigned to the center key in the second row, and “M”, “N”, “O”, and “6” are assigned to the right key in the second row. “P”, “Q”, “R”, “S”, and “7” are assigned to the left key in the third row, “T”, “U”, “V”, and “8” are assigned to the center key in the third row, and “W”, “X”, “Y”, “Z”, and “9” are assigned to the right key in the third row. “*” is assigned to the left key in the fourth row, “0” is assigned to the center key in the fourth row, and “#” is assigned to the right key in the fourth row.

In an initial state, the left key in the first row is surrounded with a thick rectangle, which means that the left key is selected. The user touches a direction button of the cross key 13 to move the thick rectangle to a desired candidate on the software keyboard pd2 so that the desired candidate is selected. In the example shown in FIG. 17, the key to which “J”, “K”, “L”, and “5” are assigned is selected.

In this state, when the user performs the operation 1 of turning on and off the finalizing button 139, as shown on the right in FIG. 17, the numeral “5” assigned to the selected key is displayed and enhanced and the alphabetical letters “J”, “K”, and “L” assigned to the selected key are displayed in leftward, upward, and rightward positions with respect to the numeral “5” on the software keyboard pd2, as shown on the left in FIG. 18.

Thereafter, when the user performs the operation 3 of touching a direction button (right button 136 in the example shown in FIG. 19), as shown on the right in FIG. 19, the numeral “5” assigned to the selected key is displayed and the alphabetical letters “J”, “K”, and “L” assigned to the selected key are displayed in the leftward, upward and rightward positions with respect to the numeral “5” on the software keyboard pd2, as shown on the left in FIG. 19.

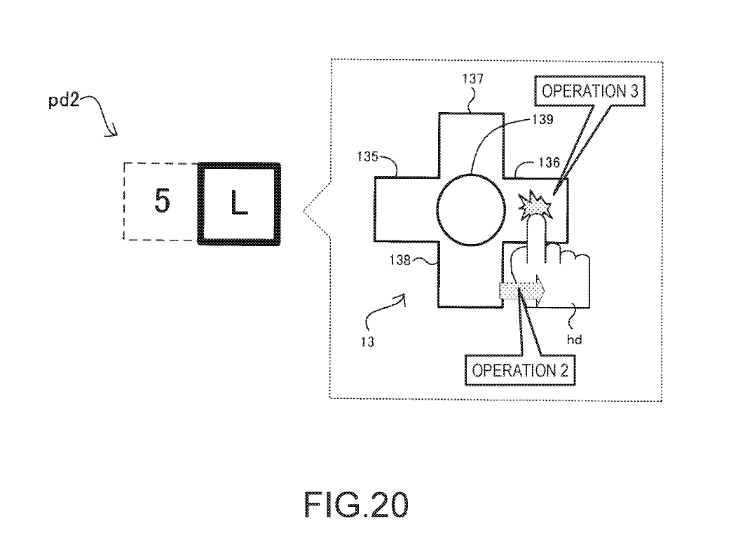

FIG. 20 describes the operation 2 and operation 3 in the pattern 2 in the second embodiment. FIG. 20 corresponds to FIG. 13 in the first embodiment. The same operation 2 and operation 3 in the pattern 2 in the first embodiment cause the alphabetical letter “L” to be outputted, as shown in FIG. 20.

According to the thus configured input apparatus (control apparatus) of the second embodiment, in a case where at least two buttons each of which can have an input-on state and an input-off state (buttons 135 to 139) are used and a result of detection of the states of the buttons contains the pre-specified patterns 1 to 4 (operation 1 to 3), a letter selected by the flick input as an alphabetical letter input method is outputted. As a result, the user can perform flick input by using the cross key 13 without using any sensor device that can acquire the trajectory of a finger or any other object but through a finger movement action that mimics an actual flick action.

### C. Third Embodiment

An HMD in a third embodiment of the invention differs from the HMDs in the first and second embodiments in that the HMD in the third embodiment has both the function of achieving the Japanese input method in the first embodiment and the function of achieving the alphabetical letter input method in the second embodiment. The thus configured HMD in the third embodiment has a configuration in which the letter input method is switched from the Japanese input method to the alphabetical letter input method and vice versa. In the following description, the same components as those in the first embodiment have the same reference characters as those in the first embodiment.

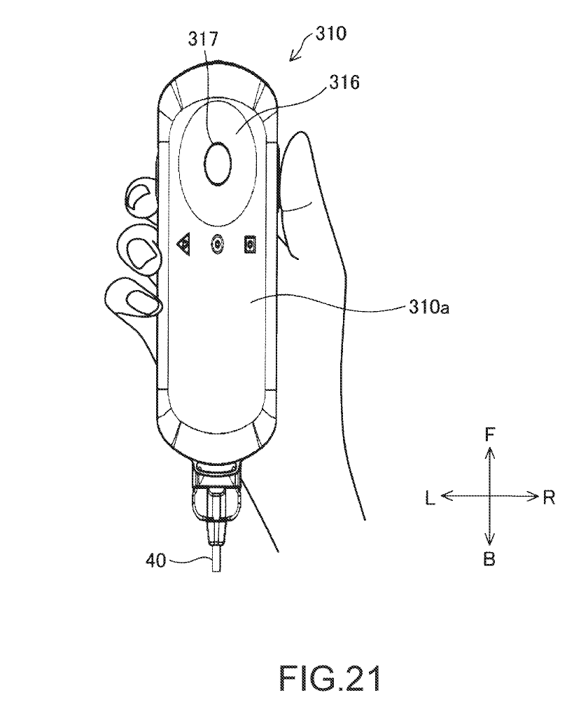

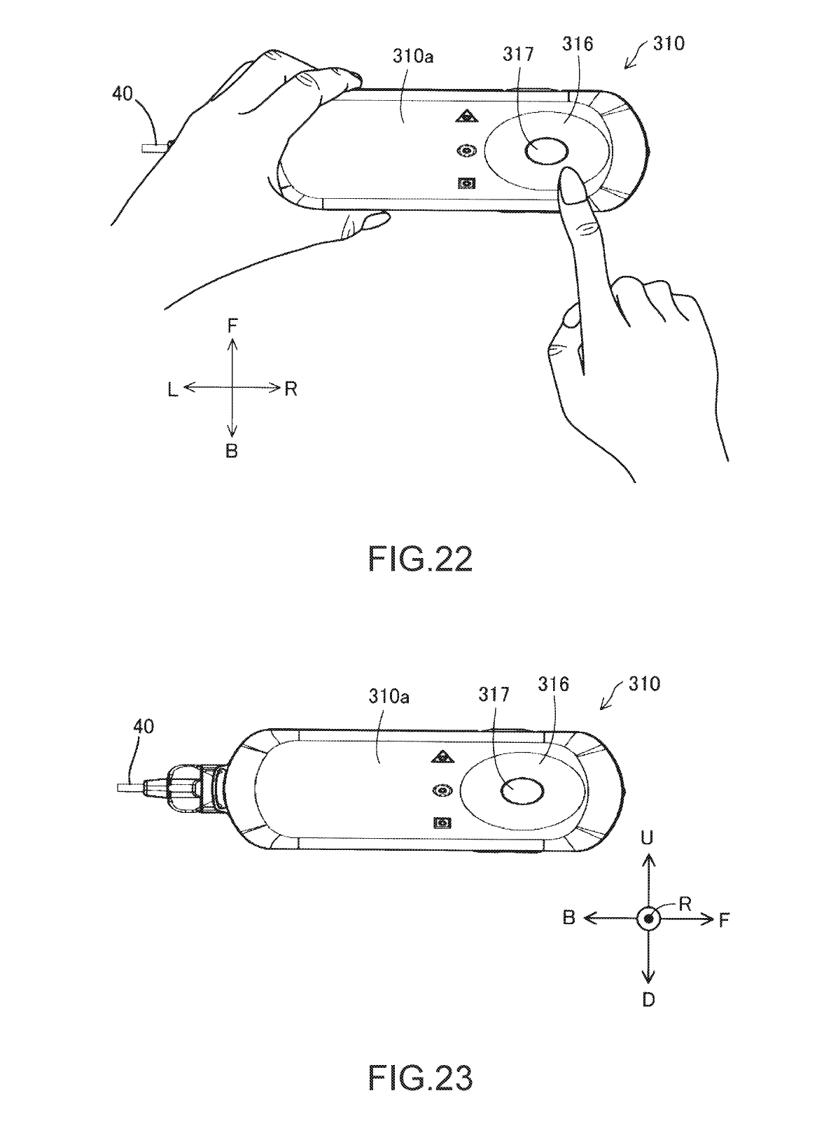

FIG. 21 is a descriptive diagram showing a first use state in which a control apparatus 310 in the third embodiment is used. FIG. 22 is a descriptive diagram showing a second use state in which the control apparatus 310 is used. The control apparatus 310 functions as an input apparatus operated by the user. The control apparatus 310 has a plate-like shape, and a direction button 316 (FIG. 22) and a finalizing button 317 (FIG. 22) are provided on a surface 310a. The direction button 316 has the configuration in the first embodiment in which the surfaces of the four direction buttons 135 to 138 are covered with a circular cover and has the same function as that of the cross key 13 in the first embodiment. The finalizing button 317 has the same function as that of the finalizing button 139 in the first embodiment. The control apparatus 310 is a replacement for the control apparatus 10 in the first embodiment, has the same function as that of the control apparatus 10, and further has the function of achieving the alphabetical letter input method in the second embodiment, as described above.

In FIGS. 21 and 22, “F” represents the front side of the user, “B” represents the back side of the user, “L” represents the left side of the user, and “R” represents the right side of the user. The control apparatus 310 is typically used with the surface 310a facing upward, the side that faces the connection cable 40 facing the back side R, and the longitudinal direction of the control apparatus 310 extending along the frontward/backward direction F/B, as shown in FIG. 21. The use state described above is the first use state or what is called a “vertical holding state.”

The control apparatus 310 can instead be used with the longitudinal direction of the control apparatus 310 extending along the rightward/leftward direction R/L. The side facing the connection cable 40 can be either the right side R or the left side L. The use state described above is the second use state or what is called a “horizontally holding state.”

The six-axis sensor 111 and the magnetic sensor 113 (see FIG. 5) are provided in the control apparatus 310, as in the control apparatus 10 in the first embodiment. The image display section 20 is also provided with the six-axis sensor 235. The control apparatus 310 can identify the orientation thereof with respect to the image display section 20 on the basis of results of detection performed by the two magnetic sensors, and the control apparatus 310 can identify the rotational speed of the control apparatus 310 on the basis of the rotational angular velocity detected with the six-axis sensor 111. As a result, the control apparatus 310 can determine whether the control apparatus 310 is in the first use state or the second use state.

In the present embodiment, when a result of the determination shows that the control apparatus 310 is in the first use state, the control apparatus 310 uses the Japanese input method to perform the letter input, whereas when a result of the determination shows that the control apparatus 310 is in the second use state, the control apparatus 310 uses the alphabetical letter input method to perform the letter input.

According to the thus configured HMD in the third embodiment, the user can perform flick input by using the direction button 316 and the finalizing button 317 without using any sensor device that can acquire the trajectory of a finger or any other object, as in the first and second embodiments. According to the HMD in the third embodiment, the Japanese input and the alphabetical letter input based on flick input can be switched from one to the other by the simple operation of holding the control apparatus 310 in the vertically or horizontally holding state.

FIG. 23 describes another configuration of the operation of switching the Japanese input to the alphabetical letter input and vice versa. In FIG. 23, “F” represents the front side of the user, “B” represents the back side of the user, “R” represents the right side of the user, “U” represents the upper side of the vertical direction, and “D” represents the lower side of the vertical direction. The user can change the orientation of the control apparatus 310 in such away that the surface 310a faces rightward or in such a way that the surface 310a faces leftward although not shown.

The control apparatus 310 causes the six-axis sensor 111 to detect whether the surface 310a faces rightward or leftward. The control apparatus 310, when it detects that the surface 310a faces rightward or leftward, carries out the process of switching the letter input between the Japanese input method and the alphabetical letter input method. That is, the control apparatus 310 having detected whether the surface 310a faces rightward or leftward switches the current letter input, when it is Japanese input, to the alphabetical letter input, whereas switching the current letter input, when it is alphabetical letter input, to the Japanese input. In other words, the control apparatus 310 sequentially switches the letter input as follows: Japanese input→alphabetical letter input→Japanese input whenever the control apparatus 310 detects that the surface 310a faces rightward or leftward. The configuration described above also allows the Japanese input and the alphabetical letter input based on flick input to be switched from one to the other in simple operation.

Further, as another configuration of the operation of switching the Japanese input and the alphabetical letter input from one to the other, the letter input may be switched between the Japanese input method and the alphabetical letter input method when the control apparatus 310 is vertically swung twice. The action of vertically swinging the control apparatus 310 twice can be detected with the six-axis sensor 111. As still another configuration of the operation of switching the Japanese input and the alphabetical letter input from one to the other, a configuration in which the user's voice is received and the letter input is switched on the basis of the voice may be employed.

As a variation of the first to third embodiments described above, the letter input mode may be reset when the orientation of the control apparatus 310 is so changed that the surface 310a faces downward (lower side of vertical direction). That is, when the orientation of the control apparatus 310 is so changed that the surface 310a faces downward, the displayed software keyboard pd or pd2 may be removed. According to the configuration, the displayed software keyboard pd or pd2 can be readily removed.

### D. Variations

In the embodiments described above, part of the configuration achieved by hardware may be replaced with software. Conversely, part of the configuration achieved by software may be replaced with hardware. In addition, the following variations are conceivable.

### Variation 1:

In the embodiments described above, the configuration of the HMD is presented by way of example. The configuration of the HMD can, however, be arbitrarily specified to the extent that the specified configuration does not depart from the substance of the invention. For example, addition, omission, conversion, and other manipulation of a component of the HMD can be performed.

In the embodiments described above, what is called a transmissive HMD 100, which allows outside light to pass through the right light guide plate 26 and the left light guide plate 28, has been described. The invention, however is also applicable, for example, to what is called a non-transmissive HMD 100, which displays an image with no outside scene visually recognized. Further, these HMDs 100 not only allow AR (augmented reality) display described in the above embodiments in which a displayed image is superimposed on the real space but also allow MR (mixed reality) display in which a combination of a captured real space image and an imaginary image is displayed or VR (virtual reality) display in which a virtual space is displayed. Further, the invention is also applicable to an apparatus that performs no AR, MR, or VR display.

In the embodiments described above, the control apparatus 10 and the image display section 20, each of which is a functional portion, have been described, and these functional portions can be arbitrarily changed. For example, the following aspects may be employed: an aspect in which the storage section 122 and the control section 150 are incorporated in the control apparatus 10 and the image display section 20 is equipped only with the display function; an aspect in which the storage section 122 and the control section 150 are incorporated in both the control apparatus 10 and the image display section 20; an aspect in which the control apparatus 10 and the image display section 20 are integrated with each other, in this case, for example, the components of the control apparatus 10 are all incorporated in the image display section 20 so that the image display section 20 is configured as a spectacle-shaped wearable computer; an aspect in which the control apparatus 10 is replaced with a smartphone or a portable game console; and an aspect in which the control apparatus 10 and the image display section 20 are connected to each other over wireless communication with no connection cable 40, in this case, for example, electric power may also be wirelessly supplied to the control apparatus 10 and the image display section 20.

### Variation 2:

In the embodiments described above, the configuration of the control apparatus is presented byway of example. The configuration of the control apparatus can, however, be arbitrarily specified to the extent that the specified configuration does not depart from the substance of the invention. For example, addition, omission, conversion, and other manipulation of a component of the control apparatus can be performed.

In the embodiments described above, an example of the input section provided as part of the control apparatus 10 has been described. The control apparatus 10 may instead be so configured that part of the input section presented by way of example is omitted or may include an input section different from the input section described above. For example, the control apparatus 10 may include an operation stick, a keyboard, a mouse, or any other component. For example, the control apparatus 10 may include an input section that interprets a command related to the user's body motion or any other motion. Detection of the user's body motion or any other motion can, for example, be sight line detection in which the line of sight is detected and gesture detection in which hand motion is detected, or the user's body motion or any other motion can be acquired, for example, with a foot switch that detects foot motion. The sight line detection can, for example, be achieved with a camera that captures an image of the interior of the image display section 20. The gesture detection can, for example, be achieved by image analysis of images captured with the camera 61 over time.

In the embodiments described above, the control section 150 operates when the main processor 140 executes the computer program in the storage section 122. The control section 150 can instead be configured in a variety of other ways. For example, the computer program may be stored, in place of the storage section 122 or in addition of the storage section 122, in the nonvolatile storage section 121, the EEPROM 215, the memory 118, and other external storage devices (including a USB memory and other storage devices inserted into a variety of interfaces and a server and other external apparatus connected via a network). The functions of the control section 150 may be achieved by using an ASIC (application specific integrated circuit) designed for achieving the functions.

### Variation 3:

In the embodiments described above, the configuration of the image display section has been presented by way of example. The configuration of the image display section can, however, be arbitrarily specified to the extent that the specified configuration does not depart from the substance of the invention. For example, addition, omission, conversion, and other manipulation of a component of the image display section can be performed.

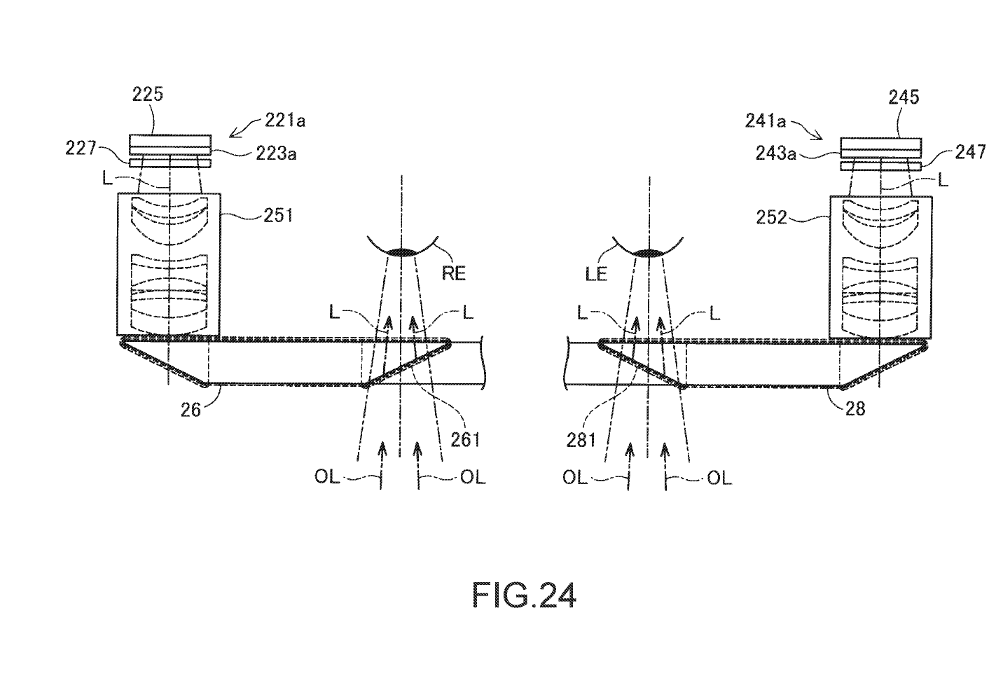

FIG. 24 is a key part plan view showing the configuration of an optical system provided in an image display section according to a variation. The image display section according to the variation is provided with an OLED unit 221a corresponding to the user's right eye RE and an OLED unit 241a corresponding to the user's left eye LE. The OLED unit 221a corresponding to the right eye RE includes an OLED panel 223a, which emits white light, and the OLED drive circuit 225, which drives the OLED panel 223a to cause it to emit the light. A modulation element 227 (modulation device) is disposed between the OLED panel 223a and the right optical system 251. The modulation element 227 is formed, for example, of a transmissive liquid crystal panel and modulates the light emitted from the OLED panel 223a to produce image light L. The modulated image light L having passed through the modulation element 227 is guided via the right light guide plate 26 to the right eye RE.

The OLED unit 241a corresponding to the left eye LE includes an OLED panel 243a, which emits white light, and the OLED drive circuit 245, which drives the OLED panel 243a to cause it to emit the light. A modulation element 247 (modulation device) is disposed between the OLED panel 243a and the left optical system 252. The modulation element 247 is formed, for example, of a transmissive liquid crystal panel and modulates the light emitted from the OLED panel 243a to produce image light L. The modulated image light L having passed through the modulation element 247 is guided via the left light guide plate 28 to the left eye LE. The modulation elements 227 and 247 are connected to a liquid crystal driver circuit that is not shown. The liquid crystal driver circuit (modulation device driver) is mounted, for example, on a substrate disposed in the vicinity of the modulation elements 227 and 247.

According to the image display section of the variation, the right display unit 22 and the left display unit 24 are configured as video elements including the OLED panels 223a and 243a, each of which serves as a light source section, and the modulation elements 227 and 247, each of which modulates light emitted from the corresponding light source section and outputs image light containing a plurality of color light fluxes. The modulation devices that modulate the light emitted from the OLED panels 223a and 243a do not necessarily have the configuration in which a transmissive liquid crystal panel is employed. For example, a reflective liquid crystal panel may be used in place of the transmissive liquid crystal panel, or a digital micromirror device may be used. A laser-retina-projection-type HMD 100 may even be provided.

In the embodiments described above, the spectacle-shaped image display section 20 has been described, and the form of the image display section 20 can be arbitrarily changed. For example, the image display section 20 may be so formed as to be mounted as a cap or may be so formed as to be built in a helmet or any other body protection gear. The image display section 20 may still instead be configured as an HUD (head-up display) incorporated in an automobile, an airplane, or any other vehicle, or any other transportation apparatus.

In the embodiments described above, the configuration in which the half-silvered mirrors 261 and 281 form virtual images in part of the right light guide plate 26 and the left light guide plate 28 is presented as an example of an optical system that guides image light to the user's eyes. The configuration can, however, be arbitrarily changed. For example, a virtual image may be formed in a region that occupies the entirety (or majority) of each of the right light guide plate 26 and the left light guide plate 28. In this case, the size of the image may be reduced by the action of changing the position where the image is displayed. Further, the optical elements in the embodiments of the invention are not limited to the right light guide plate 26 and the left light guide plate 28 having the half-silvered mirrors 261 and 282, and an arbitrary form can be employed as long as optical parts that cause the image light to be incident on the user's eyes (diffraction grating, prism, or holographic element, for example) are used.

### Variation 4:

In the embodiments described above, the input/output control has been presented byway of example. The processing contents in the input/output control can, however, arbitrarily specified to the extent that the specified contents do not depart from the substance of the invention.

In the embodiments described above, the form in which a selected candidate is surrounded with a thick rectangular frame for enhancement has been presented by way of example. The enhancement of a selected candidate can instead be performed in a variety of other aspects. For example, a selected candidate (letter itself) can be so changed that the size of the displayed candidate is increased, the brightness of the displayed candidate is changed, the position of the displayed candidate is moved, or the display form of the displayed candidate is changed as compared with the other non-selected candidates. To change the brightness of the displayed candidate, the brightness of the selected candidate may be increased or decreased in accordance with the brightness of the surroundings. To move the position of the displayed candidate, the position may be so changed that the selected candidate is moved to the center of the displayed cross region and the non-selected candidates are moved to upward, downward, rightward, and leftward positions of the displayed cross region. To change the display form of the displayed candidate, the selected candidate may be displayed in the form of a black letter or an open letter, or the font of the selected candidate may be changed. Further, the selected candidate (letter itself) may be notified in the form of voice in addition to the enhancement described above or in place of the enhancement described above. The selected candidate can therefore be enhanced by using the user's auditory sensation as well as the user's visual sensation.

### Variation 5:

The invention is not limited to the embodiments, examples, and variations described above and can be implemented in a variety of other configurations to the extent that the other configurations do not depart from the substance of the invention. For example, to solve part or entirety of the problems described above or to achieve part or entirety of the advantageous effects described above, the technical features in the embodiments, examples, and variations corresponding to the technical features in the forms described in the SUMMARY section can be swapped or combined with each other as appropriate. Further, if the technical features are not described as essential features in the present specification, they can be deleted as appropriate.

The entire disclosure of Japanese Patent Application Nos. 2016-064894, filed Mar. 29, 2016 and 2016-222259, filed Nov. 15, 2016 are expressly incorporated by reference herein.

What is claimed is:

1. An input apparatus comprising:
at least two buttons each of which is allowed to have an input-on state and an input-off state; and
a control section,
wherein the control section performs output corresponding to flick input in a case where a result of detection of the states of the buttons includes a pre-specified pattern.

2. The input apparatus according to claim 1,
wherein the at least two buttons include a finalizing button and direction buttons corresponding to upward, downward, rightward, and leftward directions, and
the pre-specified pattern corresponds to detection of the on/off state of the finalizing button, followed by detection of the on state of any one of the direction buttons.

3. The input apparatus according to claim 2,
wherein the pre-specified pattern corresponds to detection of the on/off state of the finalizing button, followed by detection of the on state of any one of the direction buttons before a pre-specified first period elapses.

4. The input apparatus according to claim 2,
wherein the pre-specified pattern corresponds to detection of the on state of the finalizing button, followed by detection of the off state of the finalizing button after a pre-specified second period elapses, further followed by detection of the on state of any one of the direction buttons.

5. The input apparatus according to claim 1,
wherein the at least two buttons include a finalizing button and direction buttons corresponding to upward, downward, rightward, and leftward directions, and
the pre-specified pattern corresponds to detection of the on/off state of the finalizing button twice, followed by detection of the on state of any one of the direction buttons.

6. The input apparatus according to claim 2,
wherein the at least two buttons are formed of a cross key having the finalizing button located at a center and the direction buttons arranged in upward, downward, rightward, and leftward directions with respect to the finalizing button.

7. The input apparatus according to claim 1,
wherein the at least two buttons are each formed of a mechanical-contact button.

8. The input apparatus according to claim 1,
wherein the at least two buttons are each formed of a capacitance button.

9. The input apparatus according to claim 1,
wherein as the output corresponding to the flick input, a letter selected by the flick input is outputted.

10. The input apparatus according to claim 1,
further comprising an interface for connection to an image display section that allows, when the input apparatus is mounted on a user's head, the user to visually recognize a virtual image,
wherein the control section further has
a function of producing image data and outputting the produced image data to the image display section, and
an operating system that allows execution of a variety of application programs, and
the control section produces a flick event according to each operation that forms the flick input and coordinates with the operation system to perform the output corresponding to the flick input.

11. The input apparatus according to claim 1,
wherein the control section further has an operating system that allows execution of a variety of application programs, and
the control section produces a flick event according to each operation that forms the flick input and coordinates with the operation system to perform the output corresponding to the flick input.

12. The input apparatus according to claim 1,
further comprising an interface for connection to an external apparatus,
wherein the control section outputs the output corresponding to the flick input to the external apparatus via the interface.

13. An input method using at least two buttons each of which is allowed to have an input-on state and an input-off state, the method comprising
causing a computer to perform output corresponding to flick input in a case where a result of detection of the states of the buttons includes a pre-specified pattern.

14. A computer program that causes a computer to provide a function of handling at least two buttons each of which is allowed to have an input-on state and an input-off state and performing output corresponding to flick input in a case where a result of detection of the states of the buttons includes a pre-specified pattern.
